(19) United States
(12) Patent Application Publication
(10) Pub. No.: US 2020/0301949 A1
(43) Pub. Date: Sep. 24, 2020

(54) SYSTEM AND METHOD FOR DETERMINING DATA PATTERNS USING DATA MINING

(71) Applicants: Andrew Ka-Ching WONG, Waterloo (CA); Peiyuan ZHOU, Waterloo (CA)

(72) Inventors: Andrew Ka-Ching WONG, Waterloo (CA); Peiyuan ZHOU, Waterloo (CA)

(21) Appl. No.: 16/823,627

(22) Filed: Mar. 19, 2020

Related U.S. Application Data
(60) Provisional application No. 62/820,598, filed on Mar. 19, 2019.

(51) Int. Cl. G06F 16/28; G06K 9/62

(52) U.S. Cl. CPC G06F 16/285; G06K 9/6223; G06F 16/288

(57) ABSTRACT

A system and method for processing relational datasets are provided, the method may include: retrieving a relational dataset containing a plurality of entities and a plurality of attribute values; constructing an entity address table, based on the relational dataset, wherein the entity address table contains the plurality of attribute values, and each of the plurality of attribute values is associated with one or more entity addresses in the relational dataset; generating a frequency table, based on the entity address table, wherein the frequency table contains one or more cardinality values; generating a SR vector space table comprising a plurality of SR values for the plurality of a pair of attribute values; generating PCs and their corresponding RSRVs through disentangling SRV into a plurality of disentangled spaces (DS); selecting from the plurality of DS, a subset of DS; and generating one or more patterns based on the plurality of DS.

### CROSS-REFERENCE TO RELATED APPLICATIONS

This application claims priority from U.S. Provisional Patent Application No. 62/820,598 filed on Mar. 19, 2019, the entire contents for which are hereby incorporated by reference herein.

### FIELD

The described embodiments generally relate to the field of data processing. More particularly, embodiments generally relate to the field of data mining (or pattern discovery) using relational databases and machine learning.

### BACKGROUND

Existing methods for discovering frequent patterns using itemset mining or pattern discovery have limitations. For example, it may be difficult to disentangle the associations to reveal statistically significant subgroup characteristics at the associate value level. Another example, they rely on exhaustive search in the entire pattern space, usually producing huge number of redundant, overlapping and entangled patterns. In a third example, their performance highly depend on the parameters/criteria set. In a fourth example, tasks like pattern discovery/pruning/summarization, pattern clustering, entity clustering, prediction/classification (including imbalanced classes and anomaly detection) have to be executed separately.

### SUMMARY

In accordance with one aspect, there is provided an example computer-implemented method for processing relational datasets, the method may include: receiving, by a processor, electronic signals representing a relational dataset containing a plurality of entities and a plurality of attribute values, the relational dataset stored on a non-transitory computer readable medium; constructing an entity address table, by the processor, based on the relational dataset, wherein the entity address table contains the plurality of attribute values (“AVs”), and each of the plurality of attribute values is associated with one or more entity addresses in the relational dataset; generating a frequency table, by the processor, based on the entity address table, wherein the frequency table contains one or more cardinality values, each of the one or more cardinality values being obtained based on a frequency of co-occurrence of at least a pair of distinct attribute values for each of the plurality of entities obtained as the cardinality of the intersection of the attribute value pair from the AV-AT; generating a SR vector space table, by the processor, the SR vector space table comprising a plurality of SR values for the plurality of a pair of attribute values, based on the frequency table, wherein each row of the vector space table, referred to as an attribute value vector, comprises at least one SR value from the plurality of SR values representative of the attribute value of the attribute value vector associating with other attribute value or plurality of attribute values corresponding to the attribute value or plurality of attribute values of the column vectors; generating PCs and their corresponding RSRVs, by the processor, through disentangling SRV into a plurality of disentangled spaces (DS); selecting from the plurality of DS, a subset of DS for AV clustering and pattern discovery; and generating one or more patterns based on the plurality of DS and the selected set of DS.

In some embodiments, the method may include: generating a set of disentangled spaces (DS), each comprising a one dimensional principal component vector space after principal component decomposition and a matrix of SR values of AVAs by re-projecting the projections of the AV vectors on the principal component to a matrix sharing the same basis vectors of the original SR vector space.

In some embodiments, the method may include: clustering AVs into AV clusters and AV sub-clusters from each of selected disentangled space (DS*); and determining patterns, pattern clusters, subgroups of pattern clusters, and rare patterns of one or more of the plurality of entities in the relational dataset based on the use of the cardinality of the intersection of AVs from the AV clusters as frequency counts of AVs co-occurring on the same entities in the pattern discovery process.

In some embodiments, the method may include: generating a vector space table, by the processor, based on the frequency table, wherein the vector space table is a vector space matrix such that each matrix element with a SR value corresponds to an AVA of its row and column representing a deviation of an observed frequency of that AVA from a default expected model if the associated value in the AVA are independent from each other.

In some embodiments, each row of the vector space table may correspond to an AV such that its coordinate corresponding to a column represents the adjusted statistical residual of that AV associating with another AV on that column in the vector matrix table.

In some embodiments, each AVA represents an association between a pair of attribute values (AV), wherein for each pair of AVs, to the SR value is used to measure a significance of frequency of the AVA occurrence. Hence all these SR values can construct the n*n SRV matrix, where n is the number of AVs.

In some embodiments, the method may include: applying, by the processor, a screening algorithm to select a second subset of DS based on a specified SR threshold value.

In some embodiments, the method may include: obtaining, by the processor principal components (PCs) and re-projected SRVs (RSRVs) by principal component decomposition (PCD) and AV-vector re-projection.

In some embodiments, the method may include: implementing, by the processor, a AV clustering process to support the determination of high order statistically significant patterns and pattern clusters for the selected disentangled spaces (DS*).

In some embodiments, the method may include: using the discovered high order statistically significant patterns and pattern clusters, and the cardinality of the AV entity ID intersection of the AVs in the AV clusters to identify statistical significant high order patterns.

In other aspects, a computer-implemented system for processing relational database is provided, the system comprising: a processor; a non-transitory computer-readable medium storing one or more programs, wherein the one or more program contain machine-readable instructions that, when executed by the processor, causes the processor to: receive electronic signals representing a relational dataset containing a plurality of entities and a plurality of attribute values, the relational dataset stored on a non-transitory computer readable medium; construct an entity address table, based on the relational dataset, wherein the entity address table contains the plurality of attribute values (“AVs”), and each of the plurality of attribute values is associated with one or more entity addresses in the relational dataset; generate a frequency table, based on the entity address table, wherein the frequency table contains one or more cardinality values, each of the one or more cardinality values being obtained based on a frequency of co-occurrence of at least a pair of distinct attribute values for each of the plurality of entities obtained as the cardinality of the intersection of the attribute value pair from the AV-AT; generate a SR vector space table, the SR vector space table comprising a plurality of SR values for the plurality of a pair of attribute values, based on the frequency table, wherein each row of the vector space table, referred to as an attribute value vector, comprises at least one SR value from the plurality of SR values representative of the attribute value of the attribute value vector associating with other attribute value or plurality of attribute values corresponding to the attribute value or plurality of attribute values of the column vectors; generate PCs and their corresponding RSRVs, through disentangling SRV into a plurality of disentangled spaces (DS); select from the plurality of DS, a subset of DS for AV clustering and pattern discovery; and generate one or more patterns based on the plurality of DS and the selected set of DS.

In some embodiments, the machine-readable instructions, when executed by the processor, causes the processor to: generate a set of disentangled spaces (DS), each comprising a one dimensional principal component vector space after principal component decomposition and a matrix of SR values of AVAs by re-projecting the projections of the AV vectors on the principal component to a matrix sharing the same basis vectors of the original SR vector space.

In some embodiments, the machine-readable instructions, when executed by the processor, causes the processor to: cluster AVs into AV clusters and AV sub-clusters from each of selected disentangled space (DS*); and determine patterns, pattern clusters, subgroups of pattern clusters, and rare patterns of one or more of the plurality of entities in the relational dataset based on the use of the cardinality of the intersection of AVs from the AV clusters as frequency counts of AVs co-occurring on the same entities in the pattern discovery process.

In some embodiments, the machine-readable instructions, when executed by the processor, causes the processor to: generate a vector space table, based on the frequency table, wherein the vector space table is a vector space matrix such that each matrix element with a SR value corresponds to an AVA of its row and column representing a deviation of an observed frequency of that AVA from a default expected model if the associated value in the AVA are independent from each other.

In some embodiments, each row of the vector space table corresponds to an AV such that its coordinate corresponding to a column represents the adjusted statistical residual of that AV associating with another AV on that column in the vector matrix table.

In some embodiments, each AVA represents an association between a pair of attribute values (AV), wherein for each pair of AVs, to the SR value is used to measure a significance of frequency of the AVA occurrence. Hence all these SR values can construct the n*n SRV matrix, where n is the number of AVs.

In some embodiments, the machine-readable instructions, when executed by the processor, causes the processor to apply a screening algorithm to select a second subset of DS based on a specified SR threshold value.

In some embodiments, the machine-readable instructions, when executed by the processor, causes the processor to obtain principal components (PCs) and re-projected SRVs (RSRVs) by principal component decomposition (PCD) and AV-vector re-projection.

In some embodiments, the machine-readable instructions, when executed by the processor, causes the processor to: implement, by the processor, a AV clustering process to support the determination of high order statistically significant patterns and pattern clusters for the selected disentangled spaces (DS*).

In some embodiments, the machine-readable instructions, when executed by the processor, causes the processor to: use the discovered high order statistically significant patterns and pattern clusters, and the cardinality of the AV entity ID intersection of the AVs in the AV clusters to identify statistical significant high order patterns.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is a schematic flow chart of a system for deep mining and discovering High Order Patterns (statistically significant associations of more than two AVs) from AVA-disentangled statistical space from data structured in accordance with an example embodiment.

FIG. 2 is an example schematic diagram of a method performed by the system in FIG. 1.

FIG. 3 illustrates a block diagram of a hardware system in accordance with an example embodiment.

FIG. 4 shows an example Entity Address Table of Attribute Values.

FIG. 5 shows an example Residual Vector Space (SRV) with Class Labels included.

FIG. 6 shows an example process of applying PCD to the SRV.

FIG. 7 shows example of AV clusters on the Principal Components and the corresponding Disentangle Spaces (DS) consisting of PCs and the corresponding RSRVs with no class labels included in the Relational Dataset (RDS).

FIG. 8 shows example result of discovered patterns by the system using test data in accordance with an example embodiment.

FIG. 9 shows another example Entity Address Table of entity (column) associating with Attribute Value Pairs and a third order AVA association (pattern) (1 on each column).

FIGS. 10A and 10B show an example of pattern entanglement and disentanglement.

FIGS. 11A and 11B show the AVAs patterns discovered in RSRVs remain the same with class labels in the Relational Data Set RDS.

FIGS. 11C and 11D show the AVAs patterns discovered in RSRVs remain the same without including class labels in the Relational Data Set RDS.

FIG. 12 shows examples of discovered High Order Patterns from different DS/PC spaces.

FIG. 13 shows the discovered High Order Patterns from different DS/PC spaces without considering class labels.

FIG. 14A illustrates results of entity clustering on a heart data set performed using K-means clustering on numerical data (N), K-means clustering on discretized data (D), and a pattern discovery and disentanglement (PDD) system, in accordance with an example embodiment.

FIG. 14B illustrates results of entity clustering on a breast cancer data set performed using K-means clustering on numerical data (N), K-means clustering on discretized data (D), and a pattern discovery and disentanglement (PDD) system, in accordance with an example embodiment.

FIG. 15 illustrates supervised classification results of a pattern discovery and disentanglement (PDD) system on a heart data set, in accordance with an example embodiment.

FIG. 16 illustrates a comparison of classification results of a pattern discovery and disentanglement (PDD) system between an original data set and the data set after removing anomalies, in accordance with an example embodiment.

FIG. 17 illustrates entity clustering results of a pattern discovery and disentanglement (PDD) system on a heart data set, in accordance with an example embodiment.

FIG. 18 illustrates a peritoneal dialysis (PD) eligible data set, in accordance with an example embodiment.

FIG. 19 illustrates patterns and attribute value clustered discovered in a peritoneal dialysis (PD) eligible data set by a pattern discovery and disentanglement (PDD) system, in accordance with an example embodiment.

FIG. 20 is a comparison of clustering by K-means and a pattern discovery and disentanglement (PDD) system with different significant levels in a peritoneal dialysis (PD) eligible data set, in accordance with an example embodiment.

FIG. 21 illustrates abnormal cases discovered by a pattern discovery and disentanglement (PDD) system in a peritoneal dialysis (PD) eligible data set, in accordance with an example embodiment.

### DETAILED DESCRIPTION

Disclosed herein include embodiments of an integrated software system, with reconfigurable hardware components, for pattern discovery and disentanglement, in particular, to discover and locate high-order patterns (such as high order statistically significant associations) in AVA Disentangled Spaces from mixed-mode relational datasets. Relational datasets can include, in an example, health care benchmark datasets such as data related to heart disease, breast cancer, and peritoneal dialysis.

In some embodiments, a heart data set can include attribute values (AV) for attributes such as age, sex, chest pain type (cpt), resting blood pressure (rbp), serum cholestoral (sc), fasting blood surge (fbs), resting ECG results (rer), maximum heart rate achieved (mhra), exercise induced angi (eia), ST depression (oldpeak), slope of peak exercise ST segment (spess), number of major vessels (nmvs), thal.

In some embodiments, a breast cancer data set can include attributes values (AV) for attributes such as clump thickness, uniformity of cell size, uniformity of cell shape, marginal adhesion, single epithelial cell size, bare nuclei, bland chromatin, normal nucleoli, and mitoses.

In some embodiments, a peritoneal analysis can include attribute values (AV) for attributes such as sex, dialysis in-patient, dialysis ICU, pre-dialysis care, pre-dialysis care for at least four months, pre-dialysis care for at least 12 months, diabetes, other cardiac condition, polycystic kidney disease, gastrointestinal bleeding, coronary artery disease, congestive heart failure, cancer, cerebrovascular disease, peripheral vascular disease, chronic obstructive lung disease, creatinine, urea, albumin, hemoglobin, parathyroid hormone, phosphate, calcium, bicarbonate, BMI, and age.

In some embodiments, the statistically significant high order patterns, pattern clusters and rare patterns, discovered in the disentangled Attribute Value Association Spaces and explicitly residing in precise location in the relational dataset (RDS) are referred to as deep knowledge since they may be masked or obscured at the data surface level due to entanglement of unknown factors in its source environment. The deep knowledge discovered in the form patterns and pattern clusters in AVA disentangled orthogonal statistical/functional spaces can be used to enhance understanding and interpretation of the data and problems at a deeper level as well as the prediction performance of Machine Learning Models. It is an important advancement of the Explainable Artificial Intelligence (XAI) and Machine Learning (ML).

In some examples, deep knowledge or patterns, determined using techniques disclosed herein, can be used for classification and clustering of conditions such as absence or presence of heart disease, benign or malignant breast conditions, and eligibility for peritoneal dialysis (PD).

Traditional pattern discovery often is an exhaustive search and hypothesis test process over a huge combinatorial number of high order Attribute Value Associations (AVAs) discovered and sorted from a RDS. Since the patterns identification process may be based on the deviation of their observed frequency of occurrences from their random default model, they could be entangled due to multiple unknown factors or their multiple entwining source environments. Hence, the patterns discovered could overlap with one another and has some level of redundancy. Usually a pattern discovery process could end up with far too many patterns which are difficult to partition, interpret and summarize. Embodiments disclosed herein may discover significant patterns based on AVAs coming from disentangled sources. The system disclosed herein may be configured to decompose the huge statistical search space composed of large number of AVAs, as well as obtain more succinct patterns, pattern clusters and even rare patterns from more function specific (or uncorrelated) sources, revealing explainable associations among attributes and their characteristics associating with the governing factors or originating sources succinctly.

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing implementation of the various example embodiments described herein.

The description provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface. For example, the programmable computers may be a server, network appliance, set-top box, embedded device, computer expansion module, personal computer, laptop, personal data assistant, cloud computing system or mobile device. A cloud computing system is operable to deliver computing service through shared resources, software and data over a network. Program code is applied to input data to perform the functions described herein and to generate output information. The output information is applied to one or more output devices to generate a discernible effect. In some embodiments, the communication interface may be a network communication interface. In embodiments in which elements are combined, the communication interface may be a software communication interface, such as those for inter-process communication. In still other embodiments, there may be a combination of communication interfaces.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Each program may be implemented in a high level procedural or object oriented programming or scripting language, or both, to communicate with a computer system. However, alternatively the programs may be implemented in assembly or machine language, if desired. In any case, the language may be a compiled or interpreted language. Each such computer program may be stored on a storage media or a device (e.g. ROM or magnetic diskette), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product including a physical non-transitory computer readable medium that bears computer usable instructions for one or more processors. The medium may be provided in various forms, including one or more diskettes, compact disks, tapes, chips, magnetic and electronic storage media, and the like. The computer useable instructions may also be in various forms, including compiled and non-compiled code.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, accelerators, receivers, transmitters, processors, memory, displays, and networks. The embodiments described herein provide useful physical machines and particularly configured computer hardware arrangements.

Embodiments of methods, systems, and apparatus are described through reference to the drawings.

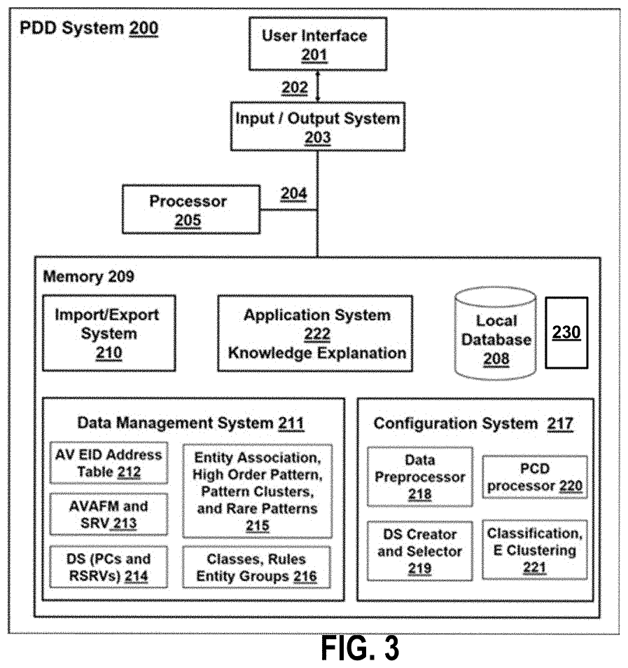

FIG. 3 is a block diagram of a hardware system 200 in accordance with an example embodiment. This system 200 includes a User interface 201, I/O connection 202, an Input/output System 203, system bus connection 204, a Processor 205, and a Memory 209.

User Interface 201 may be connected with the Input/Output System 203 via an I/O connection 202. User Interface 201 can be any device or combination of devices adapted for exchanging information between a user of User interface 201 and other elements of a pattern discovery and disentanglement (PDD) System 200. For example, User interface 201 may include a keyboard, keypad, light-pen, touch screen. User interface 201 optionally may include a conventional display screen (e.g. computer monitor) and optionally includes a web browser.

Input/Output System 203, Processor 205 and Memory 209 may be connected via a system communication 204. System communication 204 may include a bus, a computer network, or one or more electrical communication elements. For example, Communication System 204 includes a computer network.

System communication 204 may include a communication interface which enables the system 200 to communicate with other components, exchange data with other components, access and connect to network resources, serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WMAX), SS7 signaling network, fixed line, local area network, wide area network, and others, including any combination of these.

Each I/O unit 203 enables the system 200 to interconnect with one or more input devices, such as a keyboard, mouse, camera, touch screen and a microphone, or with one or more output devices such as a display screen and a speaker.

Input/Output System 203 may be configured to provide a communication interface between User Interface 201 and Processor 205, and/or Memory 209. For example, Input/Output System 203 may be optionally configured to output data to Communication System 204 in response to data received from User Interface 201. Data received through Input/Output System 203 may also be optionally configured for display using a web browser, e.g. data from cloud or external source data (not shown), in User Interface 201.

Processor 205 may run a variety of software applications and may include one or more separate integrated circuits. A processor 205 or processing device can execute instructions in memory 209 to configure various components or units 210, 222, 208, 211, 217. A processing device can be, for example, any type of general-purpose microprocessor or microcontroller, a digital signal processing (DSP) processor, an integrated circuit, a field programmable gate array (FPGA), a reconfigurable processor, or any combination thereof.

Memory 209 may include one or more long-term and/or short-term memory devices. For example, Memory 209 may include may be one or more persistent computer storage, a direct access storage device, a fixed disc drive, a floppy disc drive, a tape drive, a removable memory card, an optical storage, or the like. Memory 209 is optionally a combination of fixed and/or removable storage devices. Memory 209 optionally further comprises one or a combination of memory devices, including Random Access Memory (RAM), nonvolatile or backup memory. For example, Memory 209 contains a local database 208 used to store data, such as Relational Data Set (RDS). Besides storage, Memory 209 may include: Import/Export System 210 to import and/or export data, Data Management System 211 to store the inter/results of PDD processing, Configuration System 217 to configure the software application for PDD processing, Application System 222 to receive a request for execution of a software application and show the explainable knowledge to user through application.

Data Management System 211 may be configured to store various types of data, such as inter result or final result, in the processing of PDD. For example, Data Management System 211 may store AV EID Address Table 212, AVAFM and SRV 213, DS (Principal Components and RSRVs) 214, Entity Association, High Order Pattern, Pattern Clusters, and Rare Patterns 215, and Classes, Rules Entity Groups 216 in one or more electronic formats.

A machine-learning unit 230 may be configured to process one or more data sets representative of one or more real world measurements. In some embodiments, the machine-learning unit 230 may be configured to execute instructions to carry out supervised, unsupervised and semi-supervised machine learning such as entity classification, clustering and characterization, as well as rare pattern discovery in the imbalanced class problem in disentangled functional spaces.

Configuration System 217 may include: Data Preprocessor 218 configured for preprocessing original RDS, DS Creator and Selector 219 configured for creating and selecting dataset, PCD processor 220 configured for implementing PCD processing, Classification and Entity Clustering (E Clustering 221) configured for classification and clustering entities and displaying their patterns/rules in Disentangled AVA Spaces as well as their locations in the data.

Application system 222 may be configured to receive a request for execution. For example, the PDD system 200 may be configured to execute all processing from data to knowledge. In order to explain or show the analysis results to the user, the application system may receive an electronic request from the user and proceed to display the various facets of information to users.

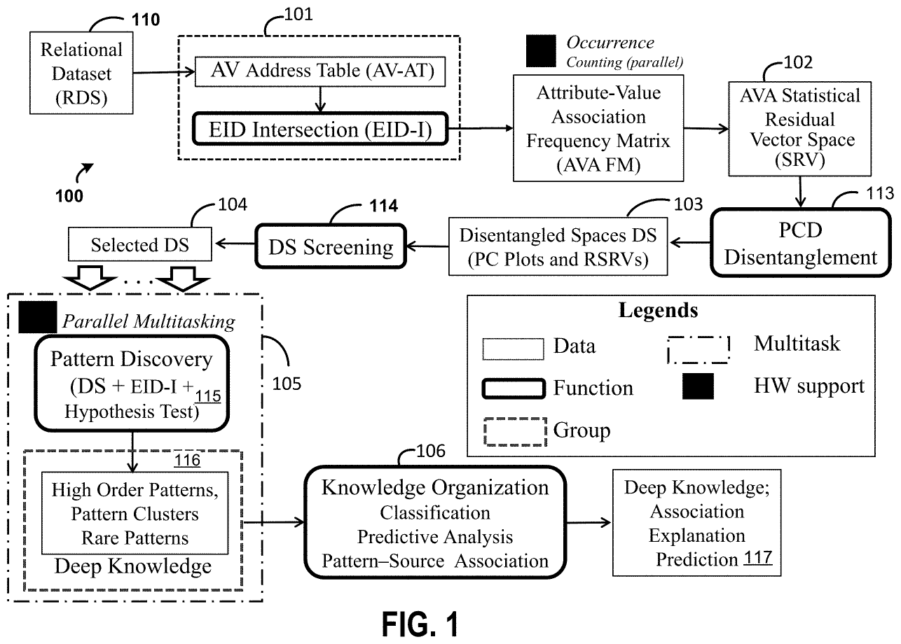

FIG. 1 shows an example system architecture and flow chart 100 for deep mining and discovering statistically significant high order patterns of attribute values associations (AVAs) from AVA-disentangled statistical space obtained from data. Given a relational dataset (RDS), the system can accomplish the proposed tasks in the steps as marked in encircled numerals. Table I below discloses a glossary adopted in this disclosure and the supplement S2.

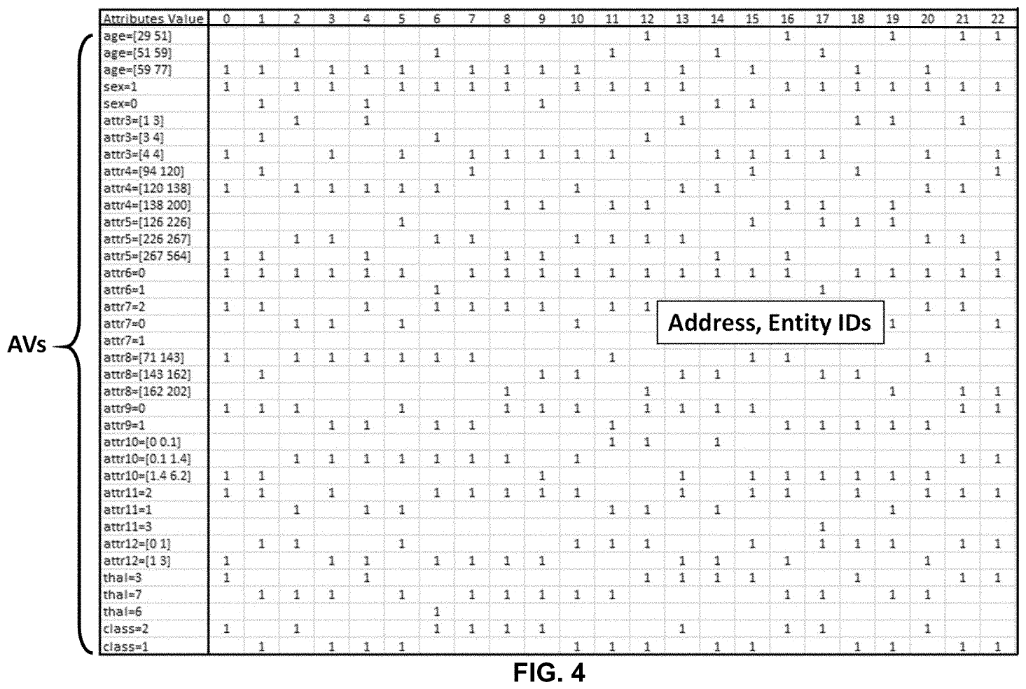

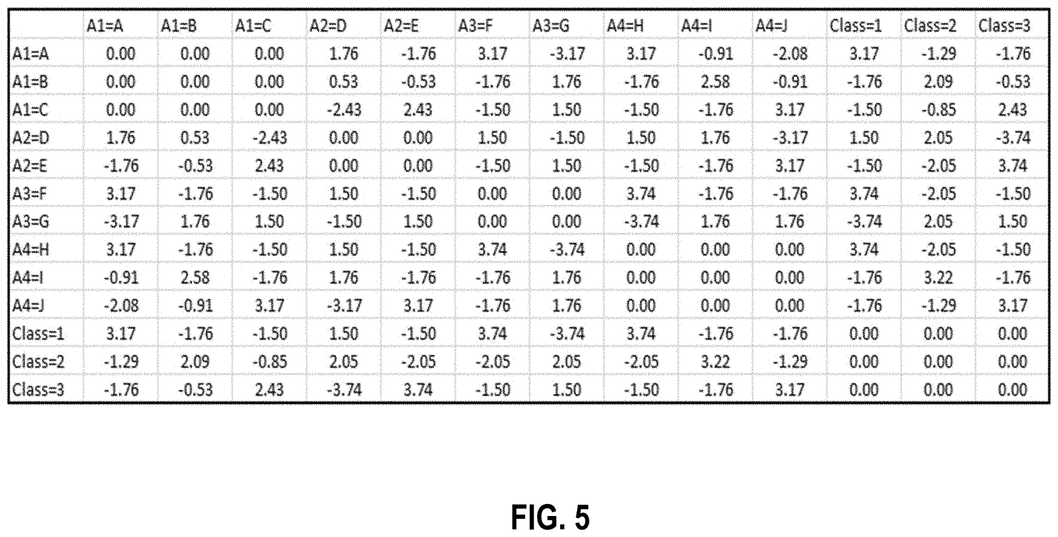

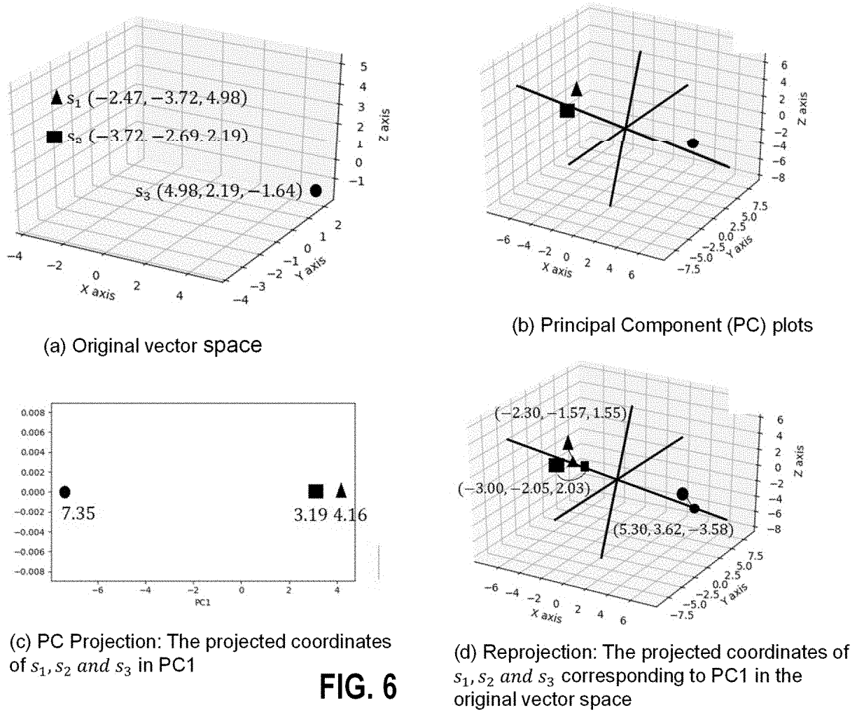

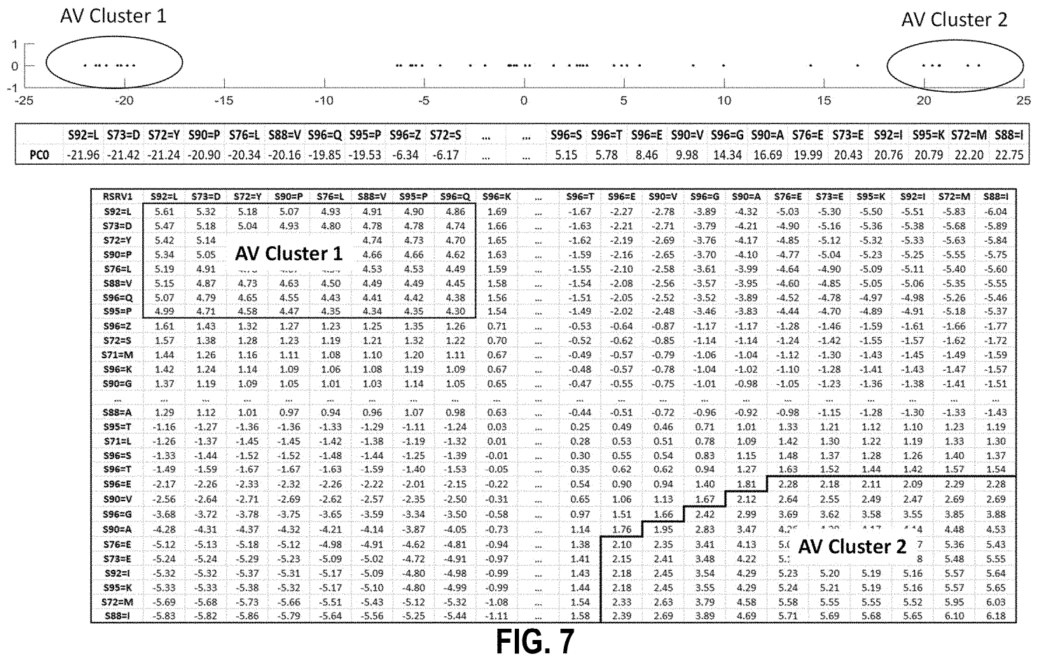

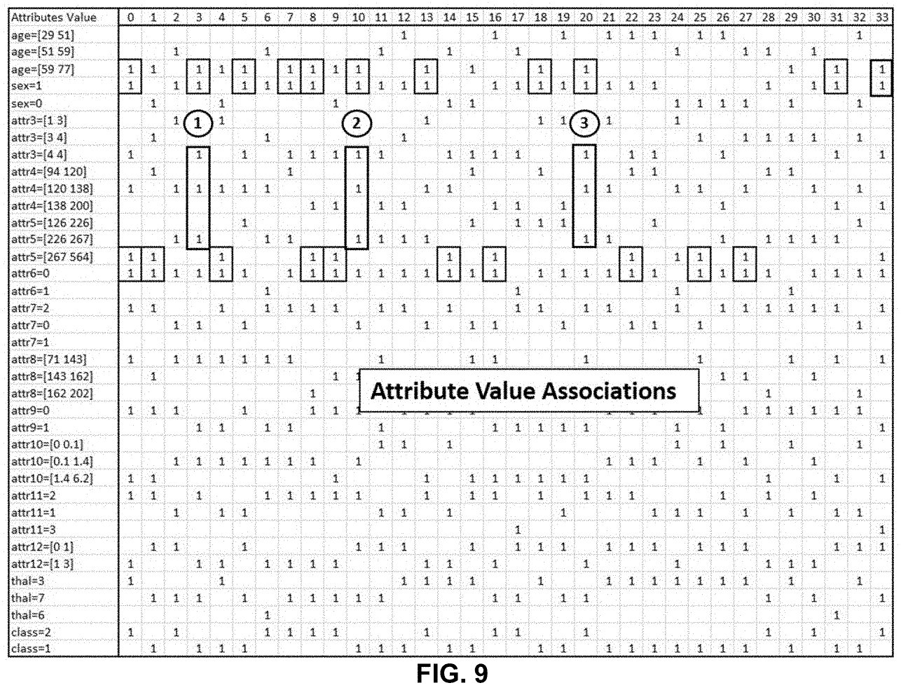

As shown in FIG. 1, one or more input may be stored in a electronic data store 110 such as a relational dataset (RDS) with numeral data discretized. The input may be, at step 101, processed to generate an AV entity address table (AV-AT) for all AVs found in RDS (see also FIG. 4). Next, an Attribute Value Association Frequency Matrix (AVA FM) 112 for RDS 110 may be generated from the cardinality of the EID intersection from each AV pair directly obtained from AV-AT rather from sorting and counting from parsing of the RDS. Next, at step 102, AVA-FM may be converted into an Adjusted Statistical Residual Vector Space (SRV) (see also FIG. 5). System 200 may then be configured to apply Principal Component Decomposition (PCD) on the SRV 102 to obtain Principal Components (PCs) 113 ranked after their eigenvalues; and to each PC (see also FIGS. 6b, 6c), projecting all the a-vectors in the SRV onto it. Next, at step 103, System 200 may be configured to re-project all a-vector projections on each PC onto a new SRV referred to as Re-Projected SRV (RSRV) (see also FIG. 6d). Then System 200 may be configured to use the coordinates of these re-projected a-vectors to reflect the SR of the AVAs between AVs captured by the PC. At 114, System 200 may be configured to perform step 104 to screen in a small set of Disentangled Spaces (DSs) each of which consists of a PC and its corresponding RSRV if the maximal SR value of the AVA in the RSRV exceeds the prescribed SR threshold. For each selected DS, System 200 may be configured to perform step 105 to obtain AV clusters on the PC from the RSRV (see also FIG. 7). At step 105, which is parallel multitasking, based on each AV cluster in a PC, a pattern discovery algorithm 115 may be implemented and run to identify high-order patterns 116 from the AV cluster if the SR estimated from the frequency of their AVs co-occurring on the same entity in the RDS exceeds the specified confidence interval. Thus, the two AVs represented in the RSRV (see also FIG. 7) form a second order pattern in the RDS captured by that PC if they are co-occurring on same entities (see also FIG. 9). As shown in FIG. 7, since each cell represents the value of association between two AVs, if the AVs in an AV cluster co-occur in the same entities of the RDS, the statistical residual (SR) of their co-occurrence can be found from their EID intersection from the AV-AT. They will form a high order pattern if the SR of their co-occurrence on the same entity in RDS exceed that of the default model if the AV co-occurrences on an entity is independent. In traditional pattern discovery, the identification of the high order associations and testing of their pattern status require exhaustive search from all the possible combination of AVs from the RDS. System 200 may be configured to obtain the SR of the high order associations from the AV clusters identified in a small set of selected DS directly from the cardinality of the EID intersections of the AVs in the cluster to obtain directly from the AV-AT in an independent, parallel multi-tasking setting. At step 106, System 200 may be configured to obtain patterns without including class label in an unsupervised setting. After DS screening, a subset of DS (DS*) and AV clusters in DS*are obtained. Upon all the discovered patterns in the AV clusters in each selected DS, all the following tasks can be conducted. After pattern discovery, the System 200 has output comprehensively all the high order statistical significant patterns in different selected DS* to form a pattern space and all entity address attached to each discovered pattern to form the Data Address Space (DAS). From here on, System 200 maybe configured to accomplish a) unsupervised pattern clusters; b) unsupervised entity clustering; c) supervised entity classification if class labels are given; d) classification of imbalance classes if the size of the class available is imbalanced and e) discovery of anomalies.

The class labels may help discover patterns, pattern clusters, AV clusters in significant or relevant PCs and the RSRVs, thus unveiling disentangled deep knowledge 117 from the RDS 110. The discovered explicit and well-formed explainable patterns and pattern clusters can be related to structures and data points obtained from the real world for practical implementations.

TABLE I
Terms and Corresponding Abbreviations

| Terms | Description |
|---|---|
| RDS | Relational Data Set |
| EID | Entity ID of an entity in RDS or APC |
| AV | Attribute Value |
| CL | Class Label (treated as an attribute value for an Attribute |
| | specified as Class) |
| SR | Adjusted Statistical Residual |
| AVA | Attribute Value Association |
| AVAFM | Attribute Value Association Frequency Matrix |
| AVASRM | Attribute Value Association Adjusted Statistical Residual |
| | Matrix |
| AVASRV | Attribute Value Association Adjusted Statistical Residual |
| (SRV) | Space |
| AV-vector | Attribute Value Vector |
| (a-vector) | |
| AT | Entity ID Address Table |
| AV-AT | Attribute Value EID Address Table (linking all EIDs to |
| | each AV) |
| PCD | Principal Component Decomposition |
| DS, DS* | Disentangle Spaces, Statistically Significant |
| | Disentangled Spaces |

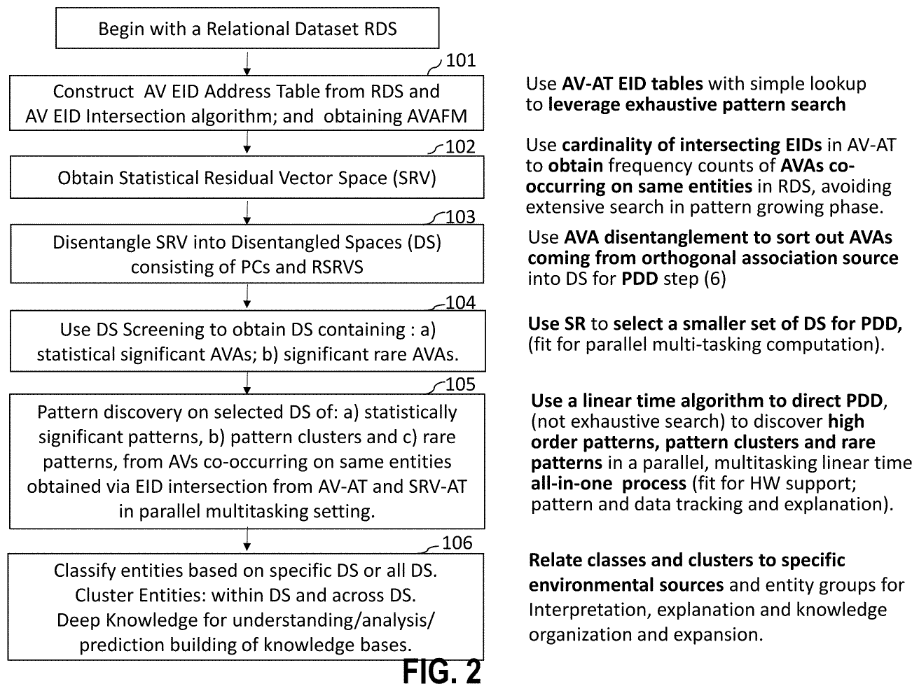

Referring now to FIG. 2, example schematic diagram of a method performed by the system in FIG. 1. At step 101, the System 200 may construct AV EID address table (AV-AT) from RDS and AV EID intersection algorithm, obtaining Attribute Value Association Frequency Matrix. At step 102, the system may obtain statistical residual vector space (SRV). At step 103, the system may disentangle SRV into disentangled spaces (DS) comprising PCs and RSRVs. At step 104, the system may use DS screening to obtain DS* if the SR in its RSRV exceeds a prescribed threshold. At step 105, the system may perform pattern discovery process on selected DS which may include one of more of: a) statistically significant patterns, b) pattern clusters and c) rare patterns, from AVs co-occurring on same entities obtained via EID-intersection from AV-AT in a parallel multitasking setting. At step 106, the system may cluster entities and/or classify entities based on one or more DS, including specific DS. Cluster entities and classification rules may be discovered within DS and across DS.

### Data Processing

One or more input data may be obtained from a relational dataset, such as a mixed-mode relational dataset R, with arbitrary number of attributes. Data preprocessing may be performed to partition attributes with real/ordinal values into discrete values with proper bin size. For real world mixed-mode dataset, the numerical attributes may be first transformed into attributes with discrete values.

In step 101 of FIGS. 1 and 2, data in the RDS may be scanned to construct an Entity Address Table for AV (AV-AT) (see e.g. FIG. 4), followed by constructing an AVAFM.

The Entity Address Table of AVs is shown in FIG. 4. The first column is the Attribute Values (AVs) found in the RDS. The top row is the EID of all the entities in RDS. The rest part is an array to store all addresses of the AVs in the AV-AT. The digit 1 indicates that the AV of that row resides on the entities referenced by the column EID. The advantage of the array version is that it can support quick searching, pattern/EID retrieval, pattern identification and pattern, entity clustering, classification rules construction (Pattern Space with class labels attached/allocated) as well as explainable knowledge retrieval and organization. For a given subset of AVs, their EID-Intersection is the intersection of their EID lists containing the entities on which the AVs reside or co-occur on the same entities in the RDS. The cardinality of the EID-Intersection is the frequency of the co-occurrences of the AV set on the same entities. They are used to enumerate the SR of their joint occurrence in the pattern discovery process.

FIG. 9 shows another example of the use of Entity Address Tables of AVs to obtain the EIDs for all the AVs (the “1” in each row) that make up a pattern. In FIG. 9, the rectangular entries illustrate the use of the EID-intersection of AV (age=[59 77]) and AV(sex=1) with cardinality [1 1] (i.e. the frequency of the AVA pair) in the construction of the AVAFM. Circled numerals show the identification, through the EID intersection of 3 AVs co-occurring that may make up a 3^{rd} order pattern if the SR obtained form that frequency exceed the default threshold. This figure shows how the cardinality of the intersection of its AV ETD's represent the frequency of the AVs in the group co-occurring on the same entities in the RDS. The frequency can be used to obtain the statistical residual for the statistical pattern test. This is quite different from the identification of the AV groups from huge pattern space obtained from the RDS and keeping the frequency counts of each high order AVA among most of the traditional method.

Also in step 101 of FIGS. 1 and 2, constructions of Attribute-Value Association Frequency Matrix is performed. Instead of sorting and counting AVAs from the RSD, the system 200 may obtain AVAFM from the cardinality of Intersections obtained from all the AVA pairs directly from the AV-AT through finding their EID-Intersections as illustrated in FIG. 9.

System 200 then may transform AVAFM into an AVA Statistical Residual Vector Space. To discern whether a frequency entry of an AVA in the AVAFM is statistically significant or is just a random happening, system 200 may transform AVAFM into an Adjusted Statistical Residual Vector Space (SRV). The adjusted statistical residual (SR) of an AVA represents the deviation of the observed frequency of the AVA from its defaulted expected model if the AVs in the AVA is independent from each other. To disentangle the AVA statistics, the AVA SR matrix may be considered and processed as a vector space, which may be referred to as a Statistical Residual Vector Space (SRV) where each row represents a vector corresponding to an AV (referred to as an AV-vector or just an a-vector) whose coordinates are the SRs of that AV associating with other distinct AVs (of other attributes) represented by the column a-vectors.

System 200 then may disentangle the SRV into DS consisting of PCs and RSRVs. As PDD System 200 attempts to discover high order statistically significant patterns from associations from disentangled sources, it first adopts an SRV disentanglement method into Principal Components (PCs) by Principal Component Decomposition (PCD). FIG. 6 shows an example process of applying PCD to the SRV. A matrix, A (i.e. a three-dimensional subspace of SRV) with 3 points is shown in FIG. 6(a) taken from the original data space. After system 200 performs PCD on A, eigenvectors and eigenvalues can be obtained and sorted in descending order according to the magnitude of their eigenvalues. FIG. 6(b) shows the PC axis with the projection of the a-vectors that maximize their variance on that PC after the transformation. FIG. 6(c) shows the coordinates of the projection of the a-vectors on the PC.

Specifically, FIG. 6(a) shows three a-vectors from the experiment as displayed in the 3-dimensional SRV Subspace. FIG. 6(b) shows a-vectors position after applying PCD on the SRV. FIG. 6(c) shows the projection of the transformed a-vectors on the PC (representing by the icons made up of dark circle, square and triangle corresponding to those on FIG. 6(b)). FIG. 6 (d) shows the re-projections of a-vector projections on the PC (as the smaller icons corresponding to the larger icons representing the a-vectors) to the RSRV subspace. The corresponding icons mark their original position in the SRV subspace. The new coordinates of the a-vector projections represent the SR of the AVs in the RSRV captured by the PC after the PCD.

System 200 may then re-project the projections of the a-vectors on the PC back to an SRV with the same basis vectors of the original SRV; this new SRV may be referred as the Re-projected SRV (denoted as RSRV). FIG. 6(d) shows the new positions of the a-vectors (icons) representing their projection on the PC to the RSRV. In each RSRV, like SRV, each row represents an a-vector corresponding to an AV with a new set of coordinates accounting the statistical strength SRs of that AV associating with other AVs captured by the PC, which is governed by certain specific underlying factors. In another word, the new transformed a-vector positions in the RSRV may correspond to a new set of AVA SRs for each AV with other AVs in the RSRV. These new positions of a-vectors reflect the AVAs captured in the corresponding PC.

In this step, SRV may be transformed into PCs and RSRVs referred to as Disentangled Space (DS). As FIG. 6(c) shows, the AV clusters can be revealed in the PC plot directly. If the projections of two AVs of different attributes are away from the centre (the point with coordinate value zero) of the PC yet close to each other, it would indicate that their second order association is strong (see the square and triangular icons in FIG. 6(c)). At the surface, it may not be immediately obvious why an a-vector is significant. However, when viewed in the RSRV, the coordinate(s) (SRs) of the a-vector of an AV reflect the statistic strength of its AVAs with other AVs and contribute to its high variance on the PC. In general, PCD is sensitive to the relative scaling of the original variables, often masking their distinctiveness. By converting the AVAFM into SRV with normalized SR scale and statistical weights, system 200 utilizes the statistical strength and functional decomposition to reveal more stable, subtle yet significant statistical associations that might be masked in the original frequency space. Hence, in this step, the significant AVAs are discovered and disentangled more distinctly, stable and specific as manifested in separate RSRVs.

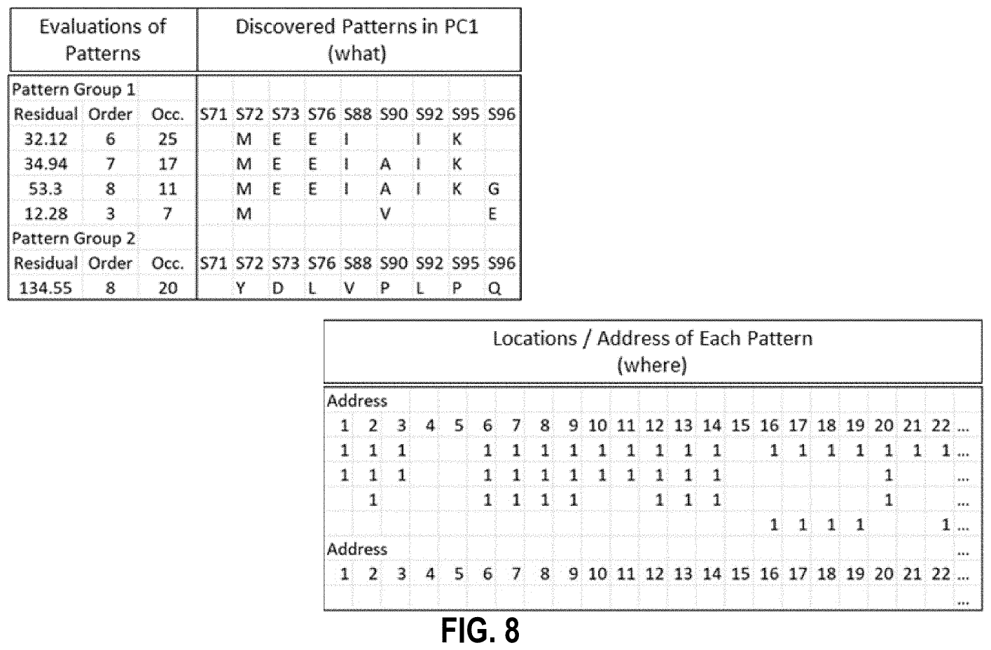

FIGS. 7 and 8 show an example of a DS with no class labels included in the RDS. FIG. 7 shows the outcome of disentanglement (step 113) on PC1 plot. It also shows the RSRVs such that each row is the re-projection of the a-vector projections (where a being the AV listed on the first column) from PC1 (step 113). The groups with enclosed border are AV Clusters obtained in step 115. They all form significant patterns in step 115. This indicates that the association to form patterns in this DS is intrinsic association without the need of referring to their class. The groups enclosed by the ellipses form pattern clusters since the cardinality of the union of their EIDs is larger than that of their intersection.

In principle, there are as many PCs as the number of AVs, which could be huge. Due to the use of SR instead of the original AVA frequency, the PCD is less sensitive to scaling and hence most of the RSRVs contain SRs much below the threshold of a specified confidence interval. If the significant associations in the uncorrelated source environment are within a reasonable range, the number of significant DS should be small. As the eigenvalue of a PC does not guarantee the inclusion of significant AVs especially when there are only a few in it, its RSRV does if their SR exceed a certain threshold (a new idea in PCD). Hence, a DS screening algorithm with a simple specified SR threshold of the maximal SR on its RSRV may be used to select a small number of DS for pattern discovery. If the AVAs in the source environment are correlated and distinct, their SR values should stand out and all the rest should be insignificant (with strong empirical support). Even if the AVA events are rare, their SR might be low, yet they still stand out from the rest. Hence, a hypothesis test can be used to check whether the maximal SR exceed a) the default statistical threshold and b) from the average SR of the rest (for rare events). Once a much smaller set of DSs have screened in, the system may apply a low complexity pattern discovery algorithm to discovery statistically significant high order patterns and pattern clusters in each DS* (e.g. step 115) in a parallel multitasking manner.

At step 116, the system may discover high order patterns and pattern clusters in each selected DS*. Up to now, all discovered disentangled AVAs in different RSRVₖ considered are of second order. Based upon these AVAs in each of the screened-in DS, a lower time-consuming algorithm using EID address intersection instead of exhaustive data searching is implemented to discover high order statistically significant patterns and pattern clusters for each DS*. System 200 may implement the algorithm to: 1) scan from each end of the PC towards the center by recruiting AV-vector, one at each time to obtain an AV group; 2) for each group label, determine the AVAs as a statistical significant pattern if the cardinality of the intersecting EIDs of the AVAs shared by its AVs exceeds the SR threshold of the pattern hypothesis test; 3) determine the AVA as a pattern if exceed the SR threshold and add it to the pattern clusters already found. System 200 may terminate the algorithm if it finds no more AV with the SR of its AVA in the RSRV exceed the set threshold.

In traditional pattern discovery, since there is no easy way to disentangle patterns arisen from multiple sources, the search and testing of many possible AVAs groups (which may not exist within the given problem domain or environment) for hypothesis testing become extensive. Due to complex entangled underlying factors, such associations could overlap with each other even they are coming from different sources. Thus, a huge number of entangled patterns usually discovered even some coming from distinct sources. Hence, in step 115 of FIGS. 1 and 2, the system may begin with discovering significant second-order patterns (AVAs) in each DS and grow them into high order AV patterns and pattern clusters. Not all possible combinations are to be confirmed, but within a much confined set on a one-dimensional PC spaces and two-dimensional RSRVs coming from the AVA disentanglement of SRV obtained from RDS. Thus, in very low time complexity, the system could check the AV co-occurrences on the entities of each AV group via from AV-AT to confirm their pattern status. Accordingly, size-wise, the patterns discovered in the DS is much smaller, and computationally, the system becomes a low complexity multitasking process, executable in a parallel manner on a much smaller set of DS.

Since the patterns are coming from disentangled sources, systems and methods disclosed herein may simplify the tracking and interpretation of the pattern sources with classes or without classes. A goal of deep knowledge discovery may be accomplished since succinct patterns and pattern clusters coming from disentangled spaces, using techniques disclosed herein, may be easier for knowledge interpretation, organization, integration and expansion.

An advantage and benefit of present system is that it is more efficient and computationally economical than previous pattern discovery and association systems. Present system 200 attempts to discover high order patterns not from the statistical space such as SRV where AVAs could be entangled due to underlying multiple unknown factors, but from separate statistical space like RSRVs where the dominating AVAs could stand out and disentangled from others. Such motivation is not only from the quality of the patterns discovered but also from the algorithmic effectiveness (step 115) and post pattern analysis (steps 116 and 106). The objective of system 200 is not to find 2nd order AV clusters in the DS, but to tackle the very challenging problem to discover high order statistical association patterns and pattern clusters as well as rare patterns in the DS simultaneously. In the past, each of these challenging tasks required special methods with extensive computation. System 200 adopts a divide-and-conquer yet integrating approach to tackle these three problems, all in one, in very low time complexity in a parallel multitasking setting that could be further exploited by a hardware accelerator.

FIG. 8 shows example results of discovered patterns in PC1 using test data. Once the high order statistical significant association patterns governed or reflected by underlying factors are discovered in the pattern space (the “what”) and located in the data space (the “where”), system 200 could render significant deep knowledge to assist pattern analysis, functional interpretation/explanation and knowledge organization. System 200 can fulfil various tasks in ML and XAI. Since the association patterns are inherent in the data and justified by statistics in orthogonal DS, system 200 renders an ideal tool that works well in supervised, unsupervised or semi-supervised setting. Below are example four tasks that can be accrued out by system 200 in the ML and XAI problem domain.

In supervised learning, in one example embodiment, if class labels are included in the RDS, or added back to the cluster of pattern clusters after pattern discovery, each pattern discovered with class labels in the disentangled space may be treated as a classification rule or the result of the classification. To build a convenient classifier, for each rule with a pattern and a class label, system 200 can enumerate the Weight of Evidence (WOE) of the pattern associating with that class against other classes and use it as a measure for classification. When a new entity is given for classification, system 200 can use the sum of +ve (−ve as well) WOE of the disentangled patterns associating with one class against the others in the organized rule base. The novelty of this approach is that system 200 can classify an unknown entity according to any interesting specific functional groups revealed in the disentangled spaces specified by the users, using the WOE of the patterns taken only from those disentangled spaces as well as all the patterns favorable to a class. In the end of classification, system 200 can determine which specific functional rules supporting the class prediction from which source environment(s) to provide post pattern discovery explainability and knowledge organization.

In unsupervised learning, in one example embodiment, the proposed task is to find clusters of entities associating with common patterns spanning in different disentangled spaces. Since system 200 can track all entities associating with a given disentangled pattern via the AT, system 200 can use the magnitude of the cardinality of the interaction of two pattern EIDs obtained from the AV-AT as a similarity measure. System 200 can use hierarchical clustering method, directed by the ranking of the discovered patterns (i.e. the relative frequency) to obtain entity clusters that share common disentangled patterns. The use of cardinality of intersecting ID addresses from the AT of the sorted patterns to direct the hierarchal clustering rather then using extensive search of patterns is novel in this invention. In pattern clustering, since no easy way to deal with the redundancy and entanglement of high order patterns, a grave problem is that there are too many overlapping pattern clusters. Through pattern disentanglement, system 200 can solve this problem to reveal pattern clusters associating with different orthogonal functionality and sources.

For semi-supervised learning, in one example embodiment, once the entity clusters in (ii) is obtained, based on the constituents of the patterns in different disentangled spaces, they can be organized and used to group and classify new entities into these functional groups. For instance, in Step 114, second order patterns (AVAs) are identified first, then higher order AV clusters are formed to support the discovery of high order patterns in step 114.

In machine learning, to discover rare patterns (or patterns occurring in imbalanced class problem) is a very challenging problem. Researchers have to create different method to accomplish such task. With DS Screening of the present system, this becomes a much straightforward process within the pattern discovery phase. If a rare AVA event (pattern) occurs in certain DS, its SR, low it may be, would still stand out from the rest in a RSRVs. A threshold may be used by system 200 to select those RSRVs satisfying a new rare event/pattern condition. If a rare AVA or AVA pattern occurs while uncorrelated with others, it would be captured in an RSRV with low SR but still standing out from the rest. Hence, system 200 can find a condition to account for how its frequency of occurrences to justify its significance in the disentangled background. If more than one AVAs satisfying such condition, system 200 can flag them for higher order pattern test in step 115. In that sense, system 200 can solve the rare event and imbalanced class/group problem with an additional DS screening process in a most efficient and effective manner during the pattern discovery phase, useful for discovering rare patterns (events) in RDS with imbalanced classes or subgroups.

### Explainable Deep Knowledge Validation and Application

Due to its capability of surfacing deep knowledge in the form of disentangle patterns and pattern groups, one aspect of system 200 is to reveal or conjecture knowledge and relate them to the established knowledge in real world via the input of expert(s), validation of domain knowledge and suggested experimental verification. System 200 can help to organize deep knowledge for interpretation, visualization, explanation, classification and analysis in a supervised, or unsupervised and/or a deep-knowledge directed semi-supervised settings. System 200 can do much robust, statistically sound and succinct tasks to unveil deep knowledge (in statistical significant high order patterns instead) for explanation, verification and further improvement of the use of knowledge for understanding and prediction.

### Parallel Computing and Hardware Accelerator

In order to reduce the computing running-time of system 200 to handle large datasets with huge volume, a novel architecture of system 200 (see e.g. FIGS. 1 and 2) is implemented for parallel computing and multi-tasking.

An accelerator board may be used in system 200. The board may have industry standard PCIe ¾ length add-in card form factor. It contains a PCIe Gen3 ×8 super fast host interface, 200 Gbps network access via dual QSFP cages, 2 NVMe onboard SSD slots, and onboard DDR4 slots support up to two 72-bit width 2400 MT/s 16 GB SO-DIMMs memory banks. All the peripherals are connected and controlled by the Xilinx Kintex Ultrascale FPGA which contains dedicate PCIe Interface Integrated block and more than 530 k logic cells.

According to some embodiments, the accelerator first fetches data either from high performance data center via QSFP interface or from local database via PCI interface. And then, the on-board microprocessor analyzes the structure of data, such as the size of data, the number of attributes, the total attribute values and so on. Next, FPGA unit can make the key operations executed in a parallel mode. The results are stored into the two onboard ultra fast NVMe SSDs by using the Ping-Pong strategy for later process use either feedback to the host PC or push back to the local database. By leveraging the FPGA based dynamic parallel architecture/technology, the time complexity of algorithm can be reduced from O(N) to O(1).

Embodiments disclosed herein can discover patterns from RDS to reveal hidden knowledge. The majority of traditional or current algorithms for mining frequent patterns rely on the frequency counts directly obtained from data from its surface values. Since the event occurrences and associations could come from multiple sources, the patterns inherent in the data might be governed or conditioned by multiple (even entangled) hidden unknown or little-known factors. Thus, what observed in the data at the surface could be entwined and deep knowledge of the subtle source environment could be masked in the observed data as evidenced by the patterns entangled in the genomic data. Some existing methods can disentangle from RDS AVAs in different DS (i.e. PCs and RSRVs). Yet the AVAs are pairwise. Thus, the AVs in PCs and AVAs in RSRVs do not reflect their co-occurrences on the same entities in the RDS. Hence, AVAs alone lacks the algorithmic assurance and the statistical robustness to ascertain that which AVA groups or high order AVA cluster may constitute a statistical significant pattern. System 200 may be implemented to solve the following problems existing in the industry:
a) There is no explicit method attempting to discover statistically significant patterns in the disentangled orthogonal spaces directly from the relational data. There is also no pattern clustering algorithm which will bring similar patterns governed by correlated association orthogonal to others together into a pattern clusters.
b) Pattern discovery usually produce overwhelming number of patterns due to source entanglement and redundancy. Because of the large number of patterns which are difficult to sort, interpretation and practical usefulness of Pattern Discovery pose a challenge.
c) Even if DS are used, its number could be huge, since the number of PCs is as large as the number of AVAs. It affects both the time and space complexity.

System 200 can: (a) turn AVA groups into high order statistical significant patterns effectively with low time complexity in a parallel multitasking setting; (b) separate patterns according to their orthogonal functionality in a small set of DS; and (c) reduce the number of DS before (a) and (b) via DS screening.

From a computational point of view, while AVAs can be taken advantage of at the attribute value level, space complexity can be expanded drastically. System 200 can trade algorithmic complexity with space complexity. It avoids computational extensive search in a large pattern space and replace computation process to direct EID address lookup and address intersection. While system 200 reduces the algorithm complexity, it raises the space complexity. An important objective of system 200 is to resolve this problem via multitasking and parallelism. That is why AT, DS Screening and AV Clustering in different PCs and finding of co-occurring EIDs from AT are created.

In both traditional supervised and unsupervised machine learning (ML), a key criterion of classification and clustering is based on the relative statistic weight of the discovered patterns pertaining to different classes/clusters. In case that the source environment is entangled, the entwined patterns are governed by several unknown factors making their class/cluster associations more intriguingly complex. Thus, patterns associating with different classes may not be as succinct as those governed by specific underlying factors. These cases may be found in prediction of residue-residue interaction (R2R-I) between interacting proteins. To-date, this problem has not been adequately addressed in ML. System 200 can solve this problem.

Recently, there is a growing need of the introducing Explainable Artificial Intelligence (XAI) or Transparent AI whose actions can be easily understood by humans. It contrasts with “black box” AIs with complex opaque algorithms, where even their designers cannot explain why a specific decision is arrived. For example, the “deep learning” methods powering cutting-edge AI in the 2010s are naturally opaque and so as other complicated neural networks and genetic algorithms.

Layerwise relevance propagation (LRP), first described in 2015, is a technique for determining which features in a particular input vector contribute most strongly to a neural network's output. Although it renders better correspondence at the output and input level yet still does not reveal subtle patterns to explain the deeper relation. Due to the nested non-linear structure, these highly successful ML and AI models are usually applied in a black box manner with no information provided about what exactly makes them arrive at their predictions. This lack of transparency can be a major drawback in application domains that requires reasoning and trusts. Although, decision trees (usually a single tree) and Bayesian networks are more transparent to inspection yet the patterns revealed are not comprehensive and sometime entwining with other decision. There has been research on extracting better understandable rules from neural networks or intemperate network, they are quite complex through extensive posteriori output-input search and corresponding processes. There is a need for more effective, direct, unbiased methodology to do a better explainable task. In some embodiments, present system can provide a more direct, unbiased, trackable and explainable method in response to the need of Explainable AI.

Discovery of Patterns that could be Entangled

Existing limitations of traditional association rule mining algorithms are as follows: 1) the performance depends on the thresholds set; and 2) it is difficult to disentangle the associations to reveal statistical significant subgroup characteristics at the AV level. Pattern clustering, pattern pruning and summarization attempt to cluster similar patterns together but the algorithmic process relies on exhaustive search in the entire pattern space and the criteria of forming pattern clusters are essentially based on similarity which does not indicate that patterns within clusters were not entangled due to some unknown factors. Therefore, to overcome these existing limitations, example embodiments of system 200 may begin with disentanglement from the most fundamental level of AVAs and recombine them into high order patterns. Hence, the patterns obtained and clustered are from disentangled orthogonal set of AVAs—more specific and succinct.

### The Use of Principal Component Decomposition (PCD)

PCD is a statistical procedure that uses an orthogonal transformation to convert a set of possibly correlated variables into a set of values of linearly uncorrelated variables called principal components (or sometimes, principal modes of variation). It has been used for decomposition of correlated variables into uncorrelated group but has not been used to reveal the disentanglement of AVAs at the AV level in the SR Spaces (RSRVs). Traditionally, PCD is used as an algorithm for dimensionality reduction and class discrimination. The fundamental notion that AVAs governed from different sources could even be entangled within classes/clusters has not been addressed. Embodiments of the present system implement a novel process which, for the first time, applies PCD for pattern discovery and disentanglement. Embodiments of the present system can go deeper to reveal the statistical functional associations as the attribute value level and it succeeds to use PCD in disentangling SRV into PCs and RSRVs. Example differences of PCD between present system and the traditional practice may include:
a. Embodiments of the present system apply PCD on SRV instead of frequency counts. Hence, it reduces the sensitivity of PCD to scaling of different dimensions and it brings out the statistical strengths in revealing association.
b. Since the eigenvalue of a PC does not guarantee the inclusion of significant AVAs especially when there are only a few in it, but its RSRV does if their SR exceed a certain threshold (a new idea in PCD). To select RSRVs that might contain significant AVA, present system uses a simple SR screening algorithm to select in a much smaller of DS from a large set produced by the PCD rather than taking top PCs with large variance. Such a shift is very important. While variance might be the result of a larger yet less significant AVA groups, the AVAs reflected by SR is more succinct and robust in pin-pointing the significant AVAs, event rare patterns with lower variance for pattern discovery.
c. Since each disentangled PCs obtained from the selected subset of DS is of one-dimension, taking the advantage of the position of a-vector projections on the PC deviating from the centre, embodiments of the present system can use a simple algorithm to expand the AV clusters and conduct the hypothesis test.
d. Since the EID of each AV and AVAs in the PC and RSRV can be directly obtained from the AT, the use of the cardinality of their intersecting EIDs to identify high order patterns in one-dimensional PC and two-dimensional RSRVs is effective and unique. Hence, unlike the traditional association mining or the search of high order AV groups to test for patterns, embodiments of the present system obtains the co-occurrence frequency for the DS in parallel without extensive search.

Embodiments of the present system can provide a simple and effective way to disentangle the AVAs captured in the SRV into orthogonal functional association statistical spaces PCs and RSRVs. It then uses a low complexity algorithm to move from both ends towards the centre of PCs and apply EID-I and hypothesis test to identify statistical significant AVA patterns in different DS governed by certain subtle orthogonal factor(s). Since the order of the patterns discovered in this manner is incremental, present system can group them into pattern clusters with pattern ranked according to the order and located in the RDS simultaneously. Thus, embodiments of the present system can solve the pattern discovery and pattern clustering at the same time. If embodiments of the present system can use the SR for rare pattern discovery, rare AV patterns can also be discovered in the same process.

Embodiments of the present system can be applied on the SRV representing the statistical weights of the AVAs with normalized scale, and hence it is less sensitive and more stable, enhancing those with statistical weights. In addition, using embodiments of the present system, the high order patterns are found more effectively on a smaller selected set of one-dimensional PC space than in N-dimensional space especially when N is large.

In traditional pattern discovery, high order patterns are identified and sorted from the expansion of lower order patterns. Since the pattern candidates to look for are in the entire pattern space, the search process is exhaustive. While AVADD was used to narrow down the search of 2nd order AVAs coming from different DS, they are not high order patterns. In contrast, present system can proposes a novel way to discover high order patterns in different DS to render a succinct way to apply, display the patterns and the analytical results for ML and XAI.

To discovery high order patterns in each one-dimensional PC space in DS*, present system performs faster in estimating the SR of the co-occurrences of the AVs within the candidate patterns on the same entities. Since embodiments of the present system can process the EIDs of all AVs and AVAs in the AV-AT, the frequency of the co-occurrences of the AVs groups in the cluster can be obtained from the cardinality of the intersecting set of their EIDs directly from the AV-AT. Hence, the frequency of occurrences of individual patterns, patterns pertaining to a pattern clusters (i.e. a subset of patterns with minor variation) and even rare patterns (of imbalance classes) can be readily obtained from the cardinality of the intersecting set of their EIDs taken directly from the AT. Thus, the AV-AT not only furnishes the location of each AV, but also provides a means to assess whether an AV cluster forms a pattern, as well as the pattern locations in the data space. Hence, embodiments of the present system can discover disentangled high order patterns, pattern clusters and rare patterns (by lowering the confidence intervals) simultaneously in disentangled PCs and RSRVs and locate them in the data space in low time complexity, making it more computationally efficient.

Furthermore, since each disentangle pattern groups are discovered in disentangled statistical space, this approach fits very well with multitasking under parallel computational mode supported by hardware accelerator.

Since embodiments of the present system can adopt divided-and-conquer strategies to operate on a large number of disentangled PCs and RSRVs simultaneously, it is a problem ideally solved by parallelism and multi-tasking. Hence, leveraging this part with reconfigurable hardware and software accelerators is a distinctive unprecedented invention for pattern discovery in ML. This invention attempts to provide economical and fast assessable memory attached to PC and/or servers to expedite the entire process for real time online application.

In classical pattern recognition, when a pattern favours a class or a cluster, certain statistical AVAs can be expected within that pattern may have strong association with the class/cluster. However, within a pattern, there could be other associations which may subject to other factors not necessarily pertaining to that class/group. The novel idea of pattern disentanglement is to identify patterns in a statistical orthogonal space which might have less chance of entangling with other patterns governed by other factors. Hence, all the patterns or rules coming out of a disentangled PC/RSRV are more unique as they are orthogonal to those in another disentangled spaces. Thus, it is more unlikely that the disentangled patterns could associate to two uncorrelated classes/clusters. Although it is not easy to reveal such subtle relation of patterns/rules between classes, yet as a practice in the ML setting, the use of disentangled patterns/rules against the entangled patterns in both supervised and unsupervised classification can be justified through rigorous learning. Embodiments of the present system can open an avenue for this novel practice.

### Experiment

A server implementing an embodiment of system 200 has been compiled. Preliminary results have shown that the system 200 has outperformed in the field of pattern discovery and knowledge discovery. System 200 has been tested using synthetic data and biological dataset. The following are results obtained using aligned pattern cluster dataset.

The aligned pattern cluster dataset is obtained from the cytochrome c protein family with taxonomic class labels. This is a small size dataset which contains samples pertaining to four taxonomical classes: Mammals, Plants, Fungi and Insects. There are in total 81 samples and nine attributes.

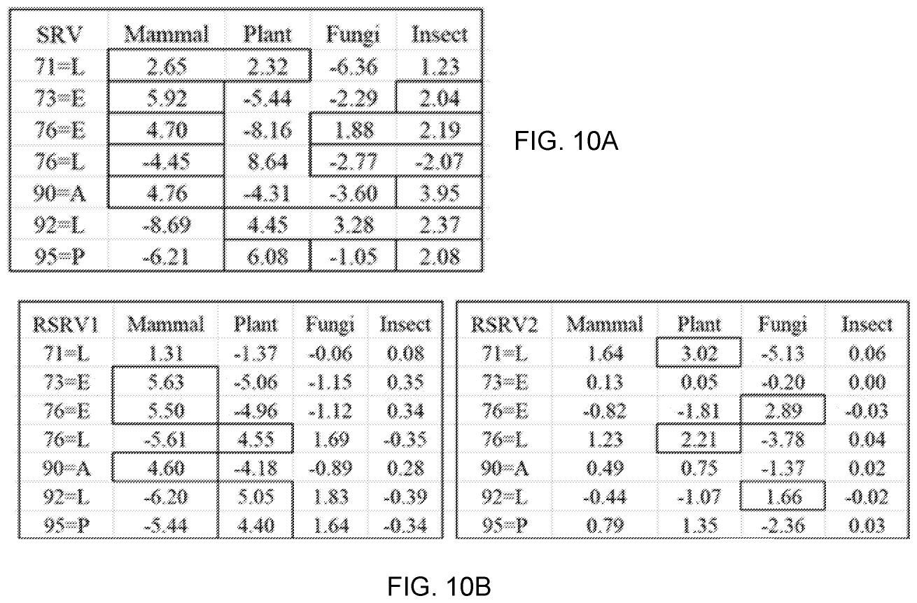

FIG. 10A shows the result using adjusted residual as measurement in APC dataset. It can be found that attribute values 71=L is entangled for Mammal and Plant; 73=E, 90=A are entangled for Mammal and Insect; 76=E is entangled for Mammal, Fungai and Insect and 92=L is entangled for Plant, Fungi and Insect; and 95=P is entangled for Plant and Insect. Later, after the disentanglement the AVAs results are shown in RSRVs (FIG. 10B). It can be noted that the class patterns are disentangled. In FIG. 10A patterns of different classes entangled in SRV. In FIG. 10B patterns disentangled in RSRVs.

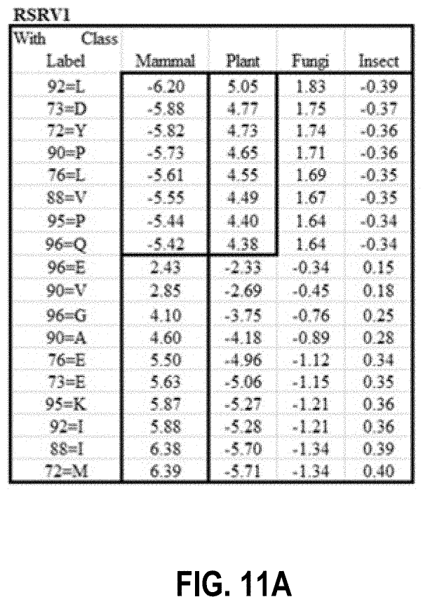

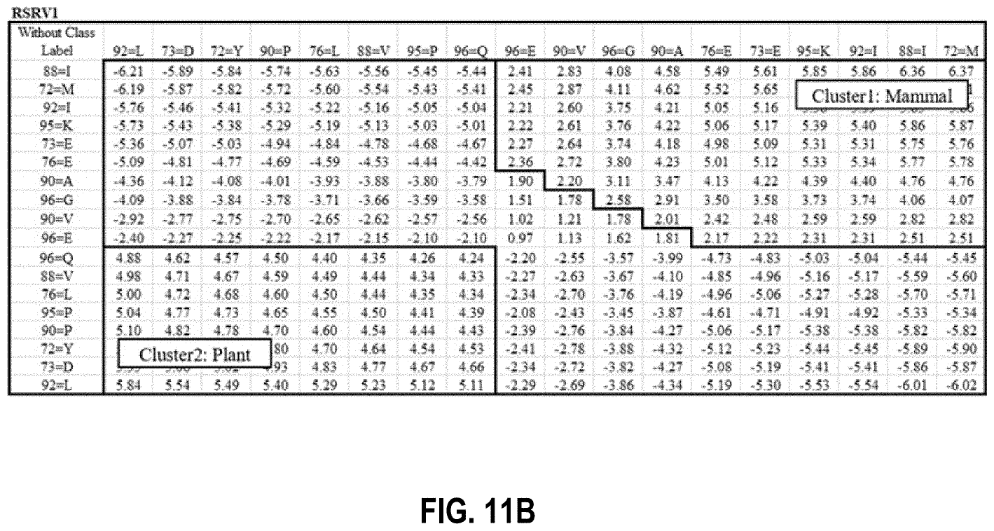

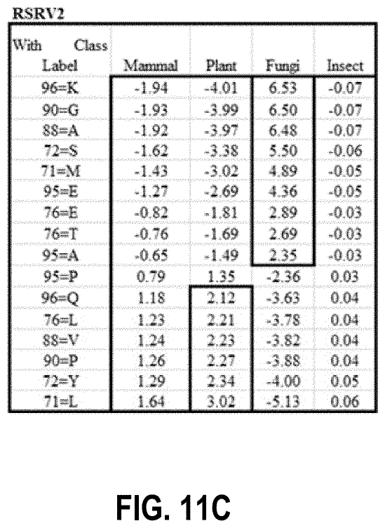

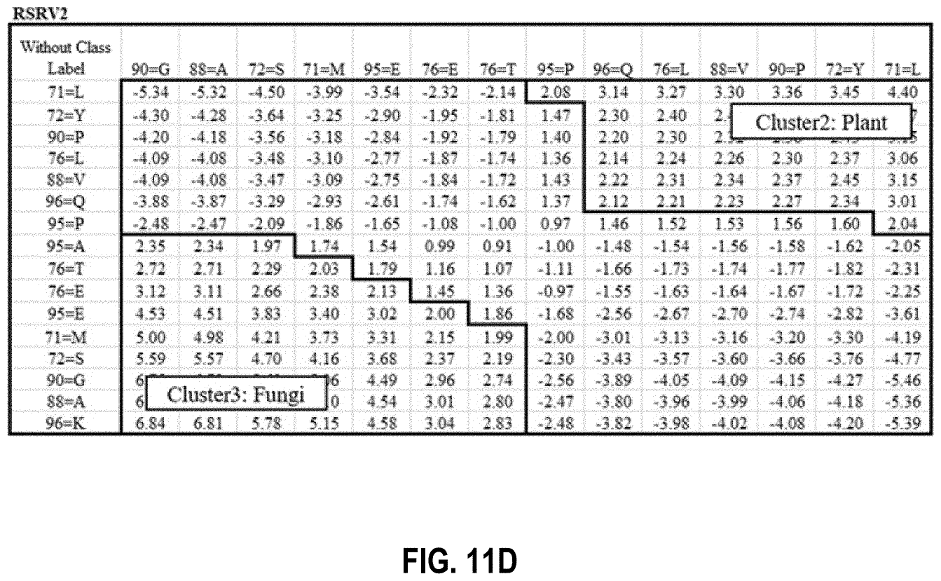

In addition, in FIG. 11A, after disentanglement, RSRV1 captured the disentangled AVA patterns for Mammal and Plant. Even without class label, the associations can still be disentangled for Mammal and Plant as FIG. 11B shows. Similarly, in FIGS. 11C and 11D, RSRV2 captured the disentangled AVA patterns for Plant and Fungi with and without class labels. FIGS. 11A to D unveil all their disentangled patterns as predefined, with or without class labels given—a robust demonstration of the deep knowledge discovered from the entangled source environment without the explicit reliance of prior knowledge or posteriori fixing.

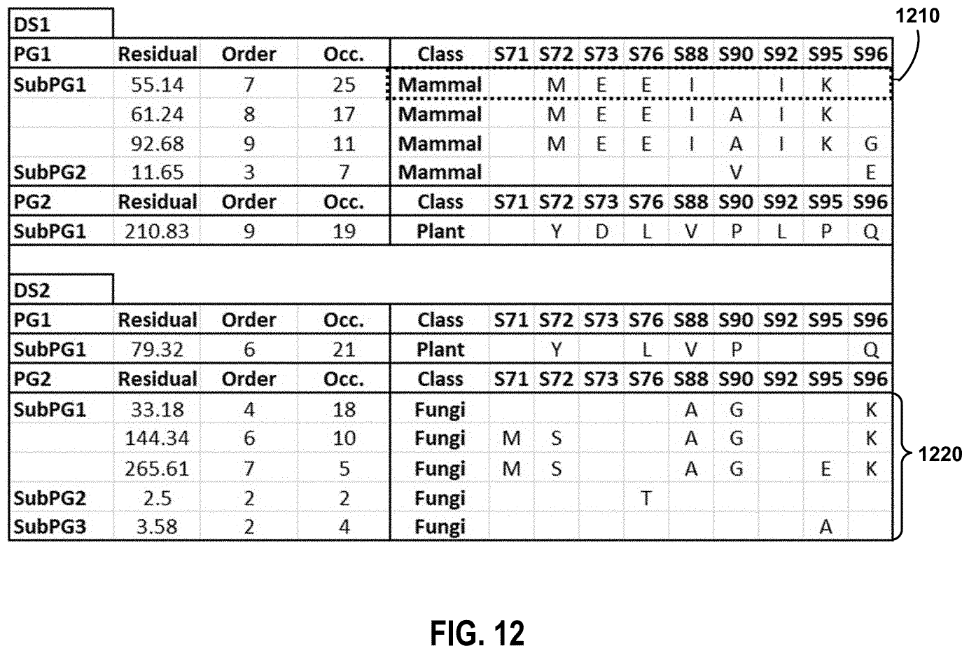

Besides the AVAs (second order patterns), embodiments of the present system can discover high order patterns. FIG. 12 shows the discovered high order patterns in different PC spaces from the aligned pattern cluster dataset with class labels. Data 1210 included within the dotted lines refers to high order pattern related with Mammal. Data 1220 refers to pattern cluster related with Fungi.

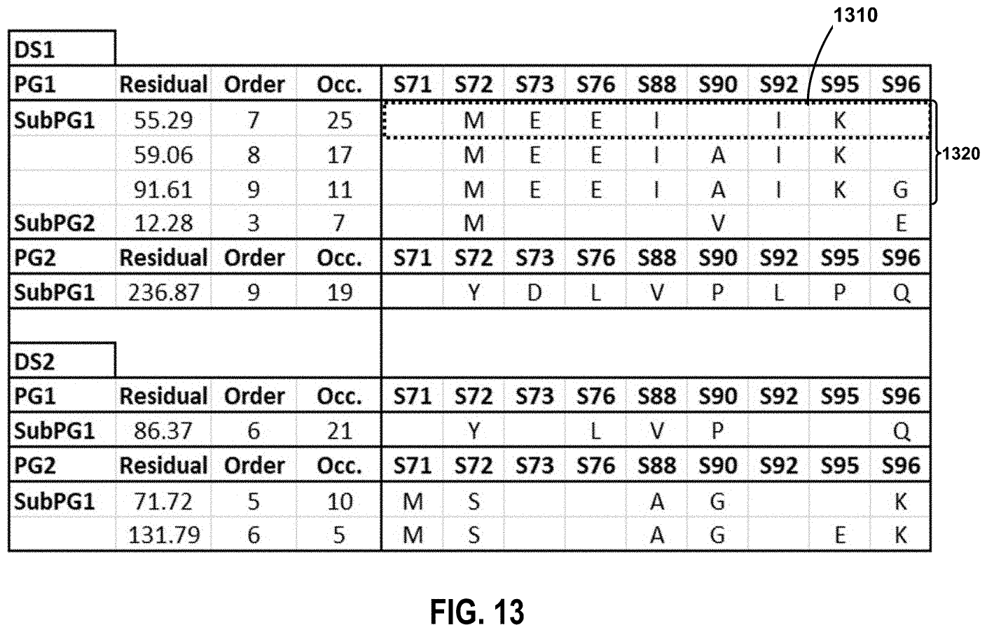

FIG. 13 shows the discovered high order patterns in different PC spaces from the dataset without class labels. Data 1310 included within the dotted lines refers to high order pattern. Data 1320 refers to pattern cluster.

If entity clustering are conducted, and pattern in each cluster without class labels are detected, system 200 is able to assign the class label to those without class label consistent with the cluster, then more complete and succinct classification results could be obtained through entity clustering based on patterns' EID addresses in the data space (FIG. 13).

In experimental work to date, there is evidence that systems and methods disclosed herein may be used to review patient records and identify patterns for detecting diseases and/or segmenting patients into different groups.

The following examples are provide particular features. A person of ordinary skill in the art will appreciate that the scope of the present disclosure is not limited to the particular features exemplified by these examples.

Heart Data Set and Breast Cancer Data Set

An embodiment of system 200 for PDD was applied to a Heart Data Set and a Breast Cancer Data Set. Heart Data Set [1] is a health care benchmark dataset from UCI repository [2], which contains 270 clinical records with 13 mixed-mode attributes in two possible classes: Absence or Presence (of heart disease). Breast Cancer Data Set [3] is a health care benchmark dataset taken from UCI repository [2], which is a classical dataset with 682 cases for discriminating the instances of two possible classes: Benign (distribution=65.5%) and Malignant (distribution=34.5%).

Attributes description for Heart Data Set are as follows:

1) Age

2) Sex

3) Cpt: chest pain type (4 values)

4) Rbp: resting blood pressure

5) Sc: serum cholestoral in mg/dl

6) Fbs: fasting blood sugar >120 mg/dl

7) Rer: resting ECG results (0,1,2)

8) Mhra: maximum heart rate achieved

9) Eia: exercise induced angi

10) Oldpeak: ST depression (exercise/rest)

11) Spess: slope of peak exercise ST segment

12) Nmvc: number of major vessels (0-3)

13) Thal: 3=normal; 6=fixed defect

Class labels for Heart Data Set are Absence/Presence of Heart Disease.

Attributes description for Breast Cancer Data Set are as follows:

1) Clump Thickness: 1-10

2) Uniformity of Cell Size: 1-10

3) Uniformity of Cell Shape: 1-10

4) Marginal Adhesion: 1-10

5) Single Epithelial Cell Size: 1-10

6) Bare Nuclei: 1-10

7) Bland Chromatin: 1-10

8) Normal Nucleoli: 1-10

9) Mitoses: 1-10

Class labels for Breast Cancer Data Set are 2 for benign, 4 for malignant condition.

Unsupervised Learning Result

When class labels are not given for clinical real cases, system 200 may have the ability to group the discovered attribute values and patient cases into different groups. Clustering performed on Heart Data Set and Breast Cancer Data Set can be scored and compared by the following criteria: Accuracy, Precision, Recall and F-measure based on given ground truth [4].

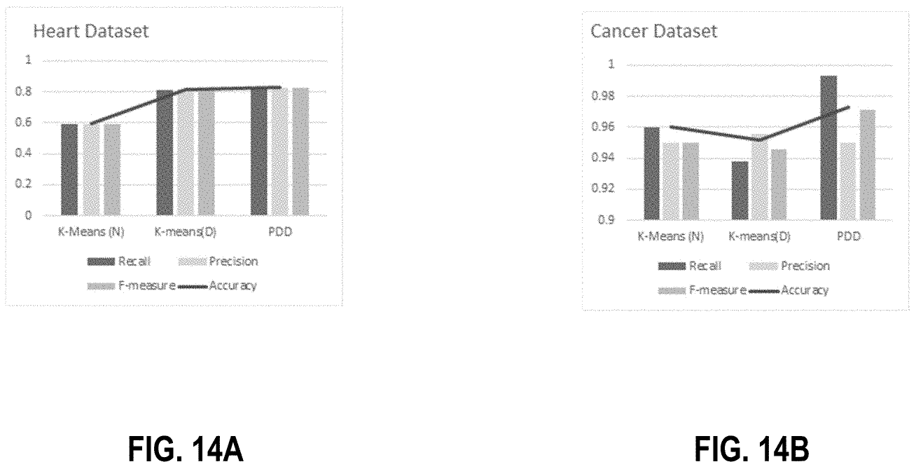

FIG. 14A and FIG. 14B show comparison results of entity clustering for the Heart Data Set and Breast Cancer Data Set, respectively, with no noise added. FIG. 14A illustrates results of entity clustering on a heart data set performed using K-means clustering on numerical data (N), K-means clustering on discretized data (D), and system 200, according to an embodiment. FIG. 14B illustrates results of entity clustering on a breast cancer data set performed using K-means clustering on numerical data (N), K-means clustering on discretized data (D), and system 200, according to an embodiment.

For the Heart Data Set, FIG. 14A shows that system 200 outperforms K-Means on both original numerical and discretized datasets in F-measure (0.82 vs 0.59 respectively) and Accuracy (82.87% vs 59.26% respectively).

For the Breast Cancer Data Set, FIG. 14B shows the results of Accuracy and F-measure of PDD vs K-Means on the discretized datasets are closer since this dataset contains less noise. Conveniently, system 200 can reveal all the patterns in the Entity Clusters while K-Means could not, which may opens the door to visualize patterns in clusters formed.

Rare Cases Detection and Classification

Furthermore, system 200 may also be able to identify anomalies and improve the classification accuracy if anomalies are identified and removed from data before training and classification, which can be illustrated using the Heart Data Set [1].

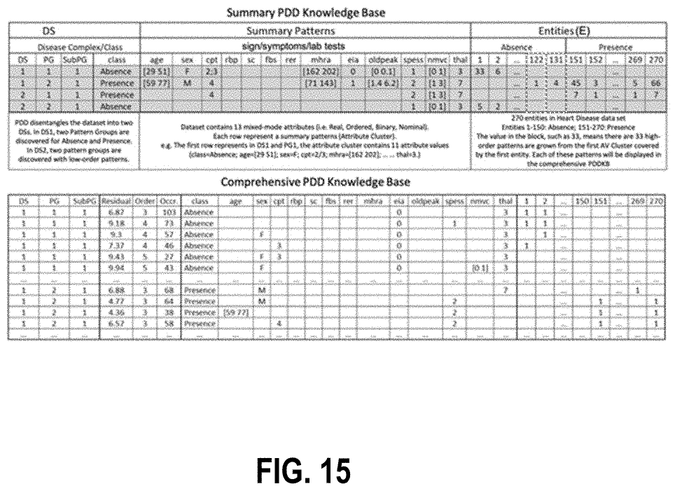

In some embodiments, system 200 can detect the following abnormal cases from clinical data: (a) outlier check: to identify outliers, and (b) abnormal entity check: to identify mislabeled entities (for example, E122 and E131 as shown in FIG. 15). Abnormal entities may arise, for example, from 1) mislabeling in a dataset; and 2) entities corresponding to a special abnormal case or an early stage of disease although being labeled as “healthy”.

FIG. 15 illustrates supervised classification results of a pattern discovery and system 200 on Heart Data Set, according to an embodiment. A summary PDD knowledge base and comprehensive PDD knowledge base are illustrated. Entities E122 and E131 are mislabeled since they are labeled as “Absence” but possess patterns pertaining to the “Presence” group.

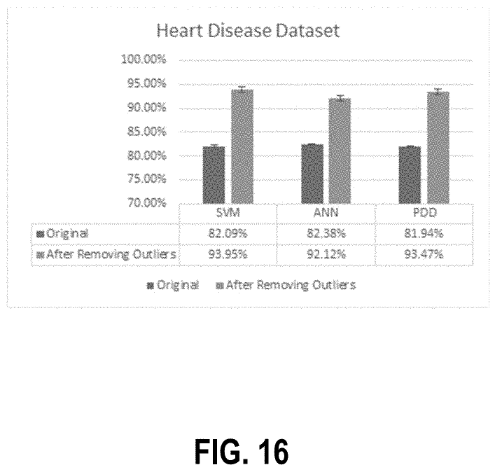

FIG. 16 illustrates a comparison of classification results of system 200 between the original Heart Data Set and a data set after removing anomalies from Heart Data Set, according to an embodiment. In the experiments, 80% of data for each class was selected randomly as training data and the rest (20%) as testing data. The average classification accuracies were obtained by 10-fold validation with variance. After the removal of anomalies, the classification results using different algorithms were improved approximately 10%.

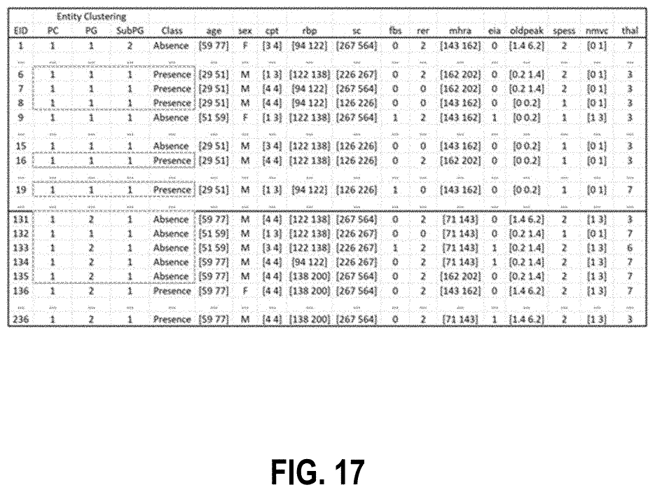

In experiments to show that system 200 can identify distinct “mislabeled” entities, all the abnormal entities and outliers were removed to produce a clean dataset which contains “Absence” entities, E1 to E130 and “Presence” entities, E131 to E237. Ten labels of the entities were then changed randomly: E6, E7, E8, E16 and E19 from “Absence” to “Presence”, and E131, E132, E133, E134 and E135 from “Presence” to “Absence”. FIG. 17 illustrates entity clustering results of system 200 on the changed Heart Data Set, according to an embodiment. From the entity clustering results illustrated in FIG. 17, the mislabeled entities found are marked in dashed line blocks. System 200 was able to identify them as mislabeled entities.

To show how anomalies may impact classification accuracy, the classification result of system 200 can be compared to other methods. Conveniently, a significant gain in system 200 may be transparency and interpretability without sacrificing accuracy, which may be important for disease diagnosis since outliers not having significant disease association and mislabeled patients in the training record may be present.

Peritoneal Dialysis Data Set

Peritoneal Dialysis (PD) is an effective home-based therapy with comparable outcomes to in-center hemodialysis (HD), with potentials to maintain a better quality of life for a patient.

In an example case study, PD data was collected using the Dialysis Measurement, Analysis and Reporting System (DMAR) and extracted from electronic medical record systems after data cleaning from multiple hospitals. The data collection process was handled by coordinators and study personnel at each of the participating sites, using both electronic and paper medical records. The data was reviewed by investigators to ensure high data quality.

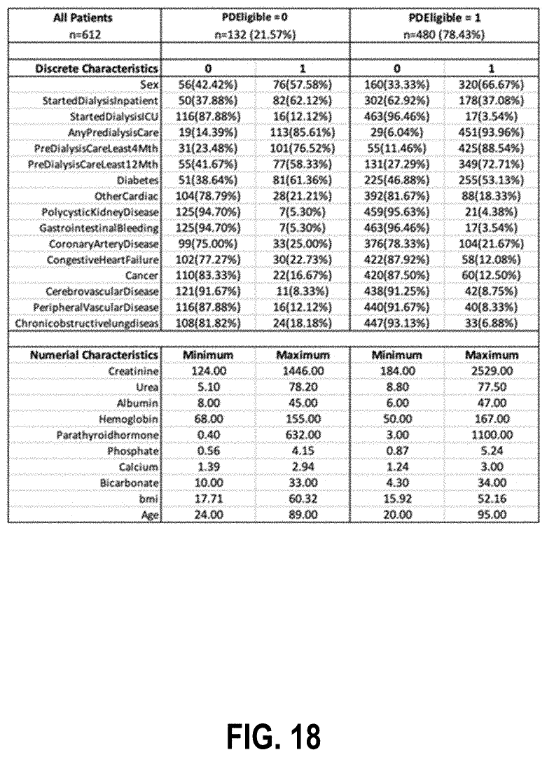

The subset of the dataset that was used in this case study consists of 612 patients with different characteristics who may or may not be eligible for PD. The PD eligible data set is illustrated in FIG. 18. There are 26 features of the dataset including demographic, physiological variables such as creatinine, hemoglobin, Phosphate, and Calcium and one class label (EligibleForPD-Class).

As FIG. 18 shows, the distribution of patients is imbalanced, for example, of the 612 patients, 480 (78.43%) are eligible for PD, and 132 (21.57%) are not eligible for PD. It can be observed that patients eligible for PD (PD Eligible=1) have higher Creatinine and parathyroidhormone. However, by relying only on the information from the statistical table, it will be impossible to summarize the most common symptoms for PD Eligibility, as the differences of the distributions of the attributes may not be directly correlated to the target variable (PD Eligibility).

In some embodiments, using system 200 for pattern discovery and disentanglement can group patients according to their covered patterns, even when class label is not given; and detect abnormal cases, for example, as a suggestion provided to medicals.

In the PD Eligibility data set illustrated in FIG. 18, each column represents an attribute, each item is an attribute value (AV), and each row contains the AV's of an entity. Since the original data is a mixed-mode data set, to discover patterns and Patterns between different attribute values, at the outset, the values of numeral attributes are quantified into interval values. When different levels are set, (i.e. two levels), different discretization could be obtained. For example, the numerical attribute value of Creatinine is from 124 to 2529. A maximum entropy algorithm can discretizes the Creatinine values into two intervals: [124, 818] and [822, 2529].

Unsupervised Learning Result

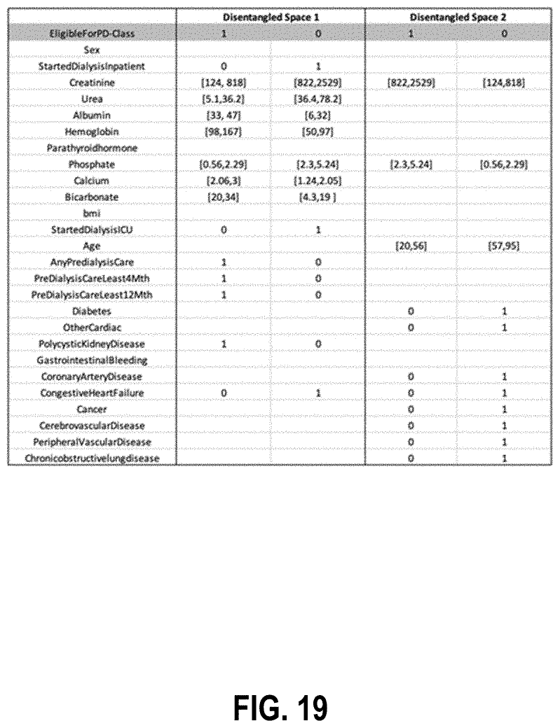

After applying system 200 on two-level discrete PD data, two disentangled spaces are obtained. For each space, two Patterns groups are discovered, as illustrated in FIG. 19. The first column lists all attributes, the second and the third columns represent two attribute value clusters (AV clusters) which are discovered in disentangled space 1 (DS1). Similarly, the fourth column and the fifth column represent AV clusters in DS2. Two AV clusters in the same DS contain mostly patterns with the same set of attributes but with different AVs. This implies that system 200 is able to identify the most discriminative attributes and their AV levels. For example, the AVs shown in the second column in FIG. 18 are associated with Eligible=0, while the AVs shown in the third column are associated with Eligible=1. Both of the above AV clusters are discovered on the opposite side in the Principal Component of the first DS (FIG. 19). It is noted in the first disentangled space (DS1), two AV clusters with different AVs among certain attributes are found associated with Eligible=0 and Eligible=1. They reveal the principal characteristics of patients in these different groups. In DS2, the second disentangled space, some subordinate AVA patterns associating to E0 and E1 are revealed.

In this case, some interval AVs in the AVA Clusters associated with PD=1 are 5.1<Urea <36.2; 33<albumin <47;2.06<calcium <3 . . . and the AVs associated with PD=0 are 36.4<Urea <78.2;1.24<calcium <2.05 . . . . For those attributes without AVs, they may not be in significant Patterns pertaining to a specific group.

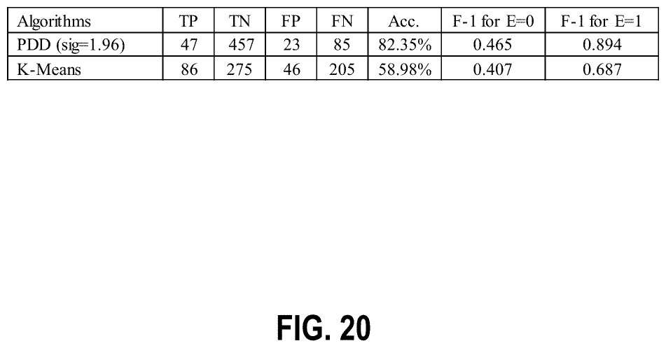

Without using class label, the system 200 can cluster the data into four entity clusters. According to the AV clusters mentioned in the above section, the entity clusters can be obtained by maximizing the overlapping between entities and different AV clusters. Since the PDD clustering process of system 200 is not based on class information, to assess the clustering accuracy, class labels are put to the entities in the clusters after clustering. To evaluate the clustering performance, unsupervised clustering accuracy and F-measure, and the harmonic mean of Precision and Recall for each category based on the class labels given in the ground truth are obtained. The comparison results with K-means shown in FIG. 20 shows that system 200 outperforms K-means significantly, especially for the cases associated with Eligible=1. The F-measure of 0.894 of PDD for class with Eligible=1 is much higher than the results of K-means. Since symptoms in the cases with Eligibility=0 are weaker and diverse, fewer significant patterns/AV-clusters are found in their data. Thus, their statistics is expected to be weaker.

Abnormal Cases Detection Result

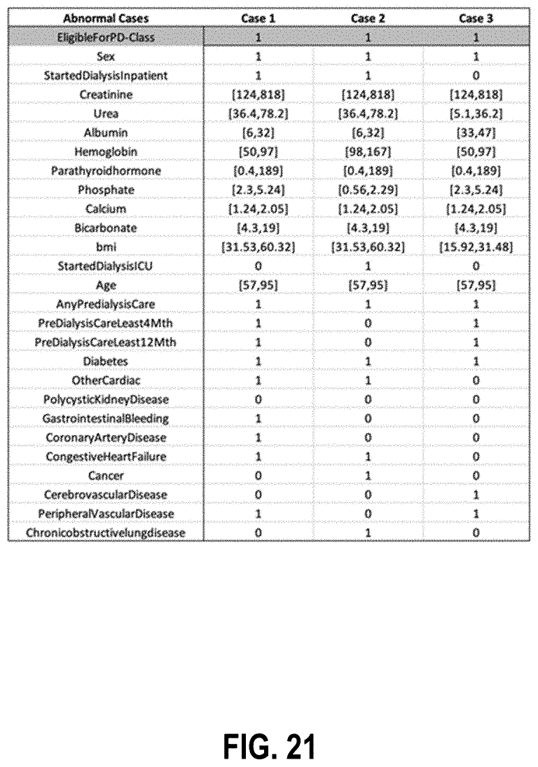

Based on pattern discovery result, system 200 can also detect abnormal cases which are defined as the entities not possessing patterns pertaining to their labeled class but to no class or other classes. FIG. 21 shows three cases that may be mislabeled, because according to the result of PDD, the attribute values of each cases are more likely associated with Eligible=0, but they are labeled as Eligible=1 in the PD dataset. These results could be a good suggestion for doctors to help them decided whether the patients need further tests to determine their eligibility, for example, for peritoneal dialysis.

### REFERENCES

[1] Statlog (Heart) Data Set,” [Online]. Available: https://archive.ics.uci.edu/ml/datasets/Statlog+(Heart).
[2] A. Asuncion and D. Newman, “UCI Machine Learning Repository,” School of Information and Computer Science, University of California, Irvine, Calif., 2007. [Online]. Available: http://archive.ics.uci.edu/ml/.
[3] W. H. Wolberg, “Breast Cancer Wisconsin (Original) Data Set,” [Online]. Available: https://archive.ics.uci.edu/ml/datasets/breast+cancer+wisconsin+(original).
[4] A. K. Wong, A. H. Y. Sze-To and G. L. Johanning, “Pattern to Knowledge: Deep Knowledge-Directed Machine Learning for Residue-Residue Interaction Prediction,” Nature Scientific Reports, vol. 8, no. 1, pp. 2045-2322, 2018.
[5] A. K. Wong and A. E. Lee, “Aligning and clustering patterns to reveal the protein functionality of sequences,” IEEE/ACM Transactions on Computational Biology and Bioinformatics (TCBB), vol. 11, no. 3, pp. 548-560, 2014.
[6] F. Whelan, C. Meehan, G. B. Golding, B. McConkey and D. M. Bowdish, “The evolution of the class A scavenger receptors.,” BMC evolutionary biology, vol. 12, no. 1, p. 227, 2012.

Throughout the foregoing discussion, numerous references will be made regarding controllers or other controller devices. It should be appreciated that the use of such terms is deemed to represent one or more software, hardware, firmware, or computing devices.

These devices may be configured to execute instruction sets that indicate gating timings, machine-readable instructions, among others, and may be configured for interoperation with other devices, for example, by way of wired or wireless interfaces.

System control signals may be in the form of a software product or firmware, stored in a non-volatile or non-transitory storage medium, which can be a compact disk read-only memory (CD-ROM), a USB flash disk, or a removable hard disk, among others, and includes a number of instructions that enable a device to execute the methods provided by the embodiments.

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification.

As can be understood, the examples described above and illustrated are intended to be exemplary only.

1. A computer-implemented method for processing relational datasets, the method comprising:
receiving, by a processor, electronic signals representing a relational dataset containing a plurality of entities and a plurality of attribute values, the relational dataset stored on a non-transitory computer readable medium;
constructing an entity address table, by the processor, based on the relational dataset, wherein the entity address table contains the plurality of attribute values (“AVs”), and each of the plurality of attribute values is associated with one or more entity addresses in the relational dataset;
generating a frequency table, by the processor, based on the entity address table, wherein the frequency table contains one or more cardinality values, each of the one or more cardinality values being obtained based on a frequency of co-occurrence of at least a pair of distinct attribute values for each of the plurality of entities obtained as the cardinality of the intersection of the attribute value pair from the AV-AT;
generating a SR vector space table, by the processor, the SR vector space table comprising a plurality of SR values for the plurality of a pair of attribute values, based on the frequency table, wherein each row of the vector space table, referred to as an attribute value vector, comprises at least one SR value from the plurality of SR values representative of the attribute value of the attribute value vector associating with other attribute value or plurality of attribute values corresponding to the attribute value or plurality of attribute values of the column vectors;
generating PCs and their corresponding RSRVs, by the processor, through disentangling SRV into a plurality of disentangled spaces (DS);
selecting from the plurality of DS, a subset of DS for AV clustering and pattern discovery; and
generating one or more patterns based on the plurality of DS and the selected set of DS.

2. The method of claim 1, further comprising:
generating a set of disentangled spaces (DS), each comprising a one dimensional principal component vector space after principal component decomposition and a matrix of SR values of AVAs by re-projecting the projections of the AV vectors on the principal component to a matrix sharing the same basis vectors of the original SR vector space.

3. The method of claim 2, further comprising:
clustering AVs into AV clusters and AV sub-clusters from each of selected disentangled space (DS*); and
determining patterns, pattern clusters, subgroups of pattern clusters, and rare patterns of one or more of the plurality of entities in the relational dataset based on the use of the cardinality of the intersection of AVs from the AV clusters as frequency counts of AVs co-occurring on the same entities in the pattern discovery process.

4. The method of claim 1, further comprising:
generating a vector space table, by the processor, based on the frequency table, wherein the vector space table is a vector space matrix such that each matrix element with a SR value corresponds to an AVA of its row and column representing a deviation of an observed frequency of that AVA from a default expected model if the associated value in the AVA are independent from each other.

5. The method of claim 4, wherein each row of the vector space table corresponds to an AV such that its coordinate corresponding to a column represents the adjusted statistical residual of that AV associating with another AV on that column in the vector matrix table.

6. The method of claim 1, wherein each AVA represents an association between a pair of attribute values (AV), wherein for each pair of AVs, to the SR value is used to measure a significance of frequency of the AVA occurrence. Hence all these SR values can construct the n*n SRV matrix, where n is the number of AVs.

7. The method of claim 2, further comprising applying, by the processor, a screening algorithm to select a second subset of DS based on a specified SR threshold value.

8. The method of claim 6, further comprising obtaining, by the processor principal components (PCs) and re-projected SRVs (RSRVs) by principal component decomposition (PCD) and AV-vector re-projection.

9. The method of claim 7, comprising: implementing, by the processor, a AV clustering process to support the determination of high order statistically significant patterns and pattern clusters for the selected disentangled spaces (DS*).

10. The method of claim 9, further comprising: using the discovered high order statistically significant patterns and pattern clusters, and the cardinality of the AV entity ID intersection of the AVs in the AV clusters to identify statistical significant high order patterns.

11. A computer-implemented system for processing relational database, the system comprising:
a processor;
a non-transitory computer-readable medium storing one or more programs, wherein the one or more program contain machine-readable instructions that, when executed by the processor, causes the processor to:
receive electronic signals representing a relational dataset containing a plurality of entities and a plurality of attribute values, the relational dataset stored on a non-transitory computer readable medium;
construct an entity address table, based on the relational dataset, wherein the entity address table contains the plurality of attribute values (“AVs”), and each of the plurality of attribute values is associated with one or more entity addresses in the relational dataset;
generate a frequency table, based on the entity address table, wherein the frequency table contains one or more cardinality values, each of the one or more cardinality values being obtained based on a frequency of co-occurrence of at least a pair of distinct attribute values for each of the plurality of entities obtained as the cardinality of the intersection of the attribute value pair from the AV-AT;
generate a SR vector space table, the SR vector space table comprising a plurality of SR values for the plurality of a pair of attribute values, based on the frequency table, wherein each row of the vector space table, referred to as an attribute value vector, comprises at least one SR value from the plurality of SR values representative of the attribute value of the attribute value vector associating with other attribute value or plurality of attribute values corresponding to the attribute value or plurality of attribute values of the column vectors;
generate PCs and their corresponding RSRVs, through disentangling SRV into a plurality of disentangled spaces (DS);
select from the plurality of DS, a subset of DS for AV clustering and pattern discovery; and
generate one or more patterns based on the plurality of DS and the selected set of DS.

12. The system of claim 11, wherein the machine-readable instructions, when executed by the processor, causes the processor to:
generate a set of disentangled spaces (DS), each comprising a one dimensional principal component vector space after principal component decomposition and a matrix of SR values of AVAs by re-projecting the projections of the AV vectors on the principal component to a matrix sharing the same basis vectors of the original SR vector space.

13. The system of claim 12, wherein the machine-readable instructions, when executed by the processor, causes the processor to:
cluster AVs into AV clusters and AV sub-clusters from each of selected disentangled space (DS*); and
determine patterns, pattern clusters, subgroups of pattern clusters, and rare patterns of one or more of the plurality of entities in the relational dataset based on the use of the cardinality of the intersection of AVs from the AV clusters as frequency counts of AVs co-occurring on the same entities in the pattern discovery process.

14. The system of claim 11, wherein the machine-readable instructions, when executed by the processor, causes the processor to:
generate a vector space table, based on the frequency table, wherein the vector space table is a vector space matrix such that each matrix element with a SR value corresponds to an AVA of its row and column representing a deviation of an observed frequency of that AVA from a default expected model if the associated value in the AVA are independent from each other.

15. The system of claim 14, wherein each row of the vector space table corresponds to an AV such that its coordinate corresponding to a column represents the adjusted statistical residual of that AV associating with another AV on that column in the vector matrix table.

16. The system of claim 11, wherein each AVA represents an association between a pair of attribute values (AV), wherein for each pair of AVs, to the SR value is used to measure a significance of frequency of the AVA occurrence. Hence all these SR values can construct the n*n SRV matrix, where n is the number of AVs.

17. The system of claim 12, wherein the machine-readable instructions, when executed by the processor, causes the processor to apply a screening algorithm to select a second subset of DS based on a specified SR threshold value.

18. The system of claim 16, wherein the machine-readable instructions, when executed by the processor, causes the processor to obtain principal components (PCs) and re-projected SRVs (RSRVs) by principal component decomposition (PCD) and AV-vector re-projection.

19. The system of claim 17, wherein the machine-readable instructions, when executed by the processor, causes the processor to: implement, by the processor, a AV clustering process to support the determination of high order statistically significant patterns and pattern clusters for the selected disentangled spaces (DS*).

20. The system of claim 19, wherein the machine-readable instructions, when executed by the processor, causes the processor to: use the discovered high order statistically significant patterns and pattern clusters, and the cardinality of the AV entity ID intersection of the AVs in the AV clusters to identify statistical significant high order patterns.
